(19) United States
(12) Patent Application Publication
(10) Pub. No.: US 2023/0220222 A1
(43) Pub. Date: Jul. 13, 2023

(54) INKJET AQUEOUS COMPOSITION, AQUEOUS INK, AQUEOUS PRIMER, AQUEOUS CLEANING LIQUID, AQUEOUS PRESERVATION LIQUID, AND INKJET RECORDING DEVICE

(71) Applicant: DIC Corporation, Tokyo (JP)

(72) Inventors: Ryota Ichikawa, Kitaadachi-gun (JP); Takahiro Nio, Kitaadachi-gun (JP); Keigo Gouda, Kitaadachi-gun (JP)

(73) Assignee: DIC Corporation, Tokyo (JP)

(21) Appl. No.: 17/914,883

(22) PCT Filed: Mar. 18, 2021
(86) PCT No.: PCT/JP2021/010970

§ 371 Date: Sep. 27, 2022

(30) Foreign Application Priority Data
Apr. 1, 2020 (JP) 2020-066111

(51) Int. Cl. C09D 11/102; C09D 11/324; C09D 11/033; C09D 11/107; C09D 11/108; C09D 11/12; C08L 83/04; B41J 2/165; C11D 3/37

(52) U.S. Cl. CPC C09D 11/102; B41J 2/165; C08L 83/04; C09D 11/12; C09D 11/033; C09D 11/107; C09D 11/108; C09D 11/324; C11D 3/373

(57) ABSTRACT

An object of the present invention is to provide an inkjet aqueous composition that can sufficiently and easily prevent deterioration or corrosion of a silicon member that forms an ink channel. The present invention relates to an inkjet aqueous composition containing an aqueous medium and a surfactant, in which the surfactant includes a polysiloxane compound having a siloxane structure (—Si—O—) with a repetition number of 5 or more and 1000 or less, and to an inkjet aqueous ink, an inkjet aqueous primer, an inkjet aqueous cleaning liquid, an inkjet aqueous preservation liquid, and an inkjet recording device.

### TECHNICAL FIELD

The present invention relates to an inkjet aqueous composition, an aqueous ink, an aqueous primer, an aqueous cleaning liquid, an aqueous preservation liquid, and an inkjet recording device.

### BACKGROUND ART

Inkjet recording is a recording method in which ink droplets are ejected from extremely fine nozzles directly onto a recording target member and attached thereto to form characters and images. This method is widely used in output machines in offices and homes because it is advantageous in that devices used produce less noise and are easy to handle and that color printing is easy and plain paper can be used as a recording target member.

On the other hand, in industrial applications, the improvement of inkjet technology has led to expectations of the use in output machines for digital printing, and printing machines capable of printing on non-absorbent base materials (plastic base materials such as PVC and PET) with solvent inks and UV inks have actually been commercially available. In recent years, however, the demand for aqueous inks has been increasing in terms of environmental awareness.

In the field of inkjet heads, there is a growing demand for inkjet heads using MEMS technology in view of the ease of manufacturing minute and high-definition heads, and the demand is expected to increasingly expand. However, it is known that the head is mainly composed of a silicon member and therefore is dissolved and deteriorated when in contact with ink (especially alkali components), leading to degradation of ejection reliability. Thus, there is a need for aqueous inkjet inks that do not deteriorate the MEMS head.

As a conventional aqueous inkjet ink, for example, an aqueous preservation liquid used for an inkjet recording head having an ink channel at least partially formed of a silicon material is disclosed, in which the aqueous preservation liquid that fills the ink channel when it is not filled with ink contains silicone oil (PTL 1). An image forming method including the step of discharging an ink composition containing at least one kind selected from silicic acid compounds from a circulation-type inkjet head is disclosed, in which the ink composition contains water-soluble silicate, colloidal silica, and the like as the silicic acid compound (PTL 2). Furthermore, an aqueous inkjet ink containing at least an organic solvent, a surfactant, and water is disclosed, in which at least (A) a water-soluble organic solvent with a boiling point of 100 to 180° C. and (B) an organic solvent with a boiling point of 200 to 280° C. and a surface tension of 20 to 30 mN/m or less are contained as the organic solvent, and 0.5 to 3% by weight of a polysiloxane surfactant is contained as the surfactant (PTL 3).

### CITATION LIST

### Patent Literature

PTL 1: Japanese Unexamined Patent Application Publication No. 2016-172351
PTL 2: Japanese Unexamined Patent Application Publication No. 2011-063000
PTL 3: Japanese Unexamined Patent Application Publication No. 2014-205768

### SUMMARY OF INVENTION

### Technical Problem

Unfortunately, in PTL 1, an aqueous ink is charged after the aqueous preservation liquid containing silicone oil is discharged from the ink channel, so when the aqueous ink flows through the ink channel, the silicone oil adsorbed on the silicon member of the ink channel is dissolved by the aqueous ink, and consequently the silicon material may be gradually dissolved. The suppression of silicon dissolution is not sufficient. In addition, it is necessary to introduce the aqueous preservation liquid into the ink channel before introducing the aqueous ink into the ink channel. This increases the process load.

PTL 2 merely discloses that the ink composition contains a water-soluble silicate (e.g., an alkali metal salt of silicic acid and an ammonium salt of silicic acid) and colloidal silica as the silicic acid compound and does not disclose that it contains a polysiloxane surfactant.

PTL 3 merely discloses that the aqueous inkjet ink contains a common polysiloxane surfactant and neither discloses nor suggests corrosion prevention of the silicon member that forms the ink channel.

An object of the present invention is to provide an inkjet aqueous composition, an aqueous ink, an aqueous primer, an aqueous cleaning liquid, an aqueous preservation liquid, and an inkjet recording device that can sufficiently and easily prevent deterioration or corrosion of a silicon member that forms an ink channel. Solution to Problem

The inventors of the present invention have conducted elaborate studies and have found that deterioration or corrosion of the silicon member can be sufficiently and easily suppressed by using an inkjet aqueous composition containing a specific polysiloxane compound having a siloxane structure (—Si—O—) with a repetition number within a predetermined range. Since the above action and effect can be easily achieved by including the inkjet aqueous composition in liquids such as ink, binder, cleaning liquid, and preservation liquid, the degree of freedom of ink design can be increased even under the increased diversity of inkjet heads such as MEMS heads formed of silicon members. This finding has led to the completion of the present invention.

Specifically, the overview of the present invention is as follows. [1] An inkjet aqueous composition containing an aqueous medium and a surfactant, in which the surfactant includes a polysiloxane compound having a siloxane structure (—Si—O—) with a repetition number of 5 or more and 1000 or less.

[2] The inkjet aqueous composition according to [1], in which the polysiloxane compound is represented by the following general formula (1) or general formula (2):

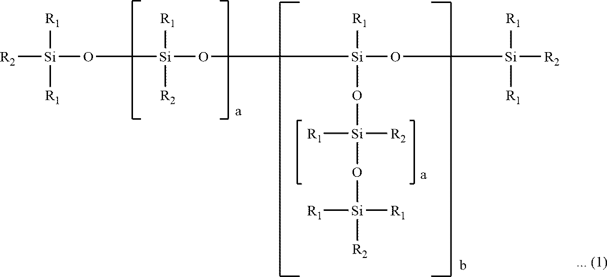

(In the formula, 5 ≤ 2+a+b(2+a) ≤ 1000, where a is an integer of 1 to 500 and b is an integer of 0 to 10. R1 represents an alkyl group or an aryl group. R2 is represented by one of the following substituents (A), (B), (C), and (D), and at least one of R2s includes (A).

### A

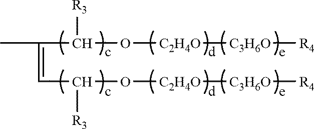

(c is an integer of 1 to 20, d is an integer of 0 to 50, and e is an integer of 0 to 50. R3 represents hydrogen atom or an alkyl group. R4 represents one of a hydrogen atom, an alkyl group, and an acyl group.)

### B

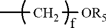

{f is an integer of 2 to 20. R5 represents one of a hydrogen atom, an alkyl group, an acyl group, and an ether group having a dimethylpropyl backbone.)

### C

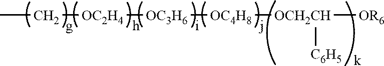

(g is an integer of 2 to 6, h is an integer of 0 to 20, i is an integer of 1 to 50, j is an integer of 0 to 10, and k is an integer of 0 to 10. R6 represents one of a hydrogen atom, an alkyl group, and an acyl group.)

### D An Alkyl Group or An Aryl Group

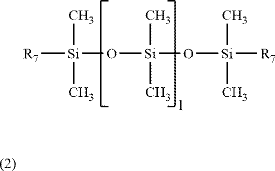

(In the formula, 5 ≤ 2+1 ≤ 82, where 1 is an integer of 10

### E

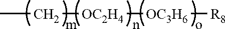

(m is an integer of 1 to 6, n is an integer of 0 to 50, o is an integer of 0 to 50, and n+o is an integer of 1 or greater. R8 represents a hydrogen atom or an alkyl group having 1 to 6 carbon atoms, or a (meth)acrylic group.)).

[3] An inkjet aqueous ink containing the inkjet aqueous composition according to [1] or [2] above and a color material.

[4] The inkjet aqueous ink according to [3] above, in which the amount of the polysiloxane compound is 0.05% by mass or more and 2.0% by mass or less of the total amount of the inkjet aqueous ink.

[5] The inkjet aqueous ink according to [3] above, further containing a binder resin.

[6] The inkjet aqueous ink according to [5] above, in which the binder resin includes a modified polyolefin.

[7] The inkjet aqueous ink according to any one of [4] to [6] above, further containing a pH adjuster, a moisturizer, an acetylene-based surfactant, and a wax resin.

[8] An inkjet aqueous primer containing the inkjet aqueous composition according to [1] or [2] above.

[9] The inkjet aqueous primer according to [8] above, in which the amount the polysiloxane compound is 0.05% by or more and 5.0% by mass or less of the total amount of the inkjet aqueous primer.

[10] The inkjet aqueous primer according to [8] above, further containing a binder resin.

[11] The inkjet aqueous primer according to [8] above, further containing a pH adjuster, a moisturizer, and an acetylene-based surfactant.

[12] An inkjet aqueous cleaning liquid containing the inkjet aqueous composition according to [1] or [2] above.

[13] The inkjet aqueous cleaning liquid according to [12] above, in which the amount of the polysiloxane compound is 0.05% by mass or more and 10% by mass or less of the total amount of the inkjet aqueous cleaning liquid.

[14] An inkjet aqueous preservation liquid containing the inkjet aqueous composition according to [1] or [2] above. [15] The inkjet aqueous preservation liquid according to [14] above, in which the amount of the polysiloxane compound is 0.05% by mass or more and 10% by mass or less of the total amount of the inkjet aqueous preservation liquid.

[16] An inkjet recording device including an inkjet head into which the inkjet aqueous composition according to [1] or [2] above is introduced, in which

the inkjet head includes an ink channel into which the inkjet aqueous composition is supplied, a nozzle connected to the ink channel, and an ink ejection hole disposed at a distal end of the nozzle, and

a distance L from a surface (x) having the ink ejection hole of the inkjet head to a position (y) where a normal to the surface (x) intersects a recording target member is 1 mm or more.

[17] The inkjet recording device according to [16] above, in which

the ink channel, the nozzle, and the ink ejection hole are integrally formed in a Si substrate, and

the surface (x) having the ink ejection hole is formed at one of main surfaces of the Si substrate. Advantageous Effects of Invention

with the present invention, deterioration or corrosion of the silicon member that forms the ink channel can be sufficiently and easily suppressed.

### BRIEF DESCRIPTION OF DRAWINGS

FIG. 1 is a cross-sectional view schematically illustrating an exemplary configuration of an inkjet head provided in an inkjet recording device according to the present embodiment.

### DESCRIPTION OF EMBODIMENTS

Embodiments of the present invention will be described in detail below with reference to the drawing.

### Constitution of Inkjet Aqueous Composition

An inkjet aqueous composition according to the present embodiment contains an aqueous medium and a surfactant.

### Aqueous Medium

The aqueous medium includes water. Examples of the water include pure water or ultrapure water, such as ionexchange water, ultra-filtrated water, reverse osmosis water, and distilled water. The amount of the aqueous medium is not limited but may be 90% by mass or less or 80% by mass or less of the total amount of the inkjet aqueous composition. The amount of the aqueous medium is 30% or more and may be 40% by mass or more. The amount of the aqueous medium is preferably 30 to 90% by mass, more preferably 40 to 80% by mass of the total amount of the inkjet aqueous composition.

The inkjet aqueous composition may contain a solvent component other than water (e.g., organic solvent) for adjustment of viscosity or the like. When a mixed solvent of water and a solvent component other than water (e.g., organic solvent) is used, the amount of the aqueous medium is, for example, but not limited to, 40% by mass or more and may be 50% by mass or more. The water-soluble organic solvent may be a known water-soluble organic solvent used for inkjet inks.

Examples of the water-soluble organic solvent include ketones such as acetone, methyl ethyl ketone, methyl butyl ketone, and methyl isobutyl ketone; alcohols such as 2-methanol, ethanol, isopropyl alcohol, 1-propanol, 2-propanol, 2-methyl-1-propanol, 1-butanol, 2-butanol, and 2-methoxyethanol; ethers such as tetrahydrofuran, 1,4-dioxane, and 1,2-dimethoxyethane; dimethylformamide, N-methylpyrrolidone, glycols such as ethylene glycol, diethylene glycol, triethylene glycol, tetraethylene glycol, propylene glycol, dipropylene glycol, polyethylene glycol, and polypropylene glycol; diols such as butanediol, pentanediol, hexanediol, and homologous diols thereof; glycol esters such as propylene glycol laurate; glycol ethers such as cellosolve including diethylene glycol monoethyl ether, diethylene glycol monobutyl ether, diethylene glycol monohexyl ether, propylene glycol ether, dipropylene glycol ether, and triethylene glycol ether; sulfolane; lactones such as γ-butyrolactone; lactams such as N-(2-hydroxyethyl)pyrrolidone; glycerol, diglycerol, polyglycerol, diglycerol fatty acid esters, polyoxypropylene (n) polyglyceryl ether represented by general formula (3), and polyoxyethylene (n) polyglyceryl ether represented by general formula (4). These can be used singly or in combination of two or more.

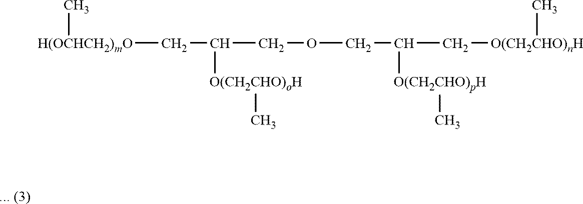

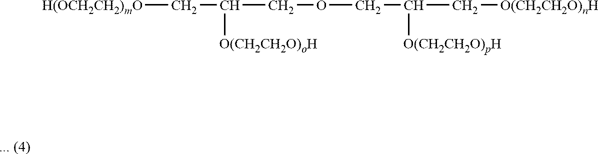

In general formula (3) and general formula (4), m, n, o, and p are each independently an integer of 1 to 10.

Examples of the organic solvent include 3-methoxy-1-butanol, 3-methyl-3-methoxy-1-butanol, 3-methoxy-3-methyl-1-butyl acetate, ethylene glycol monomethyl ether, ethylene glycol monoethyl ether, ethylene glycol monopropyl ether, ethylene glycol monobutyl ether, ethylene glycol monoisobutyl ether, ethylene glycol-t-butyl ether, propylene glycol monomethyl ether, propylene glycol monoethyl ether, propylene glycol monopropyl ether, propylene glycol monomethyl ether acetate, diethylene glycol dimethyl ether, diethylene glycol methyl ethyl ether, diethylene glycol diethyl ether, dipropylene glycol dimethyl ether, 4-methoxy-4-methyl-2-pentanone, and ethyl lactate. These can be used singly or in combination of two or more.

### Surfactant

The surfactant includes a polysiloxane compound having a siloxane structure (—Si—O—) with a repetition number of 5 or more and 1000 or less. The repetition number of the siloxane structure in the polysiloxane compound is preferably 6 or more and 500 or less and more preferably 7 or more and 200 or less. If the repetition number of the siloxane structure is less than 5, the effect of suppressing deterioration or corrosion of the silicon member fails to be achieved. If the repetition number of the siloxane structure exceeds 1000, the solubility of the polysiloxane compound decreases and the polysiloxane compound is easily separated in the aqueous medium. The repetition number of the siloxane structure in the polysiloxane compound is therefore set within the above range.

The polysiloxane compound can be represented by the following general formula (1) or general formula (2). With the use of the polysiloxane compound represented by the following general formula (1) or general formula (2), corrosion of the silicon member can be deterioration or sufficiently and easily prevented.

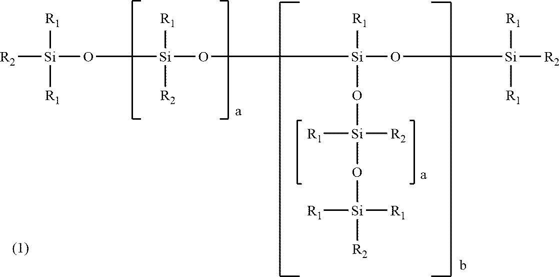

(In the formula, 5 ≤ 2+a+b(2+a) ≤ 1000, where a is an integer of 1 to 500 and b is an integer of 0 to 10. R1 represents an alkyl group or an aryl group. R2 is represented by one of the following substituents (A), (B), (C), and (D), and at least one of R2s includes (A).

### A

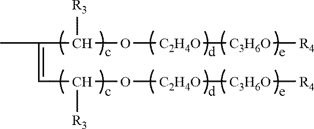

(c is an integer of 1 to 20, d is an integer of 0 to 50, and e is an integer of 0 to 50. R3 represents hydrogen a atom or an alkyl group. R4 represents one of a hydrogen atom, an alkyl group, and an acyl group.)

### B

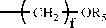

(f is an integer of 2 to 20. R5 represents one of a hydrogen atom, an alkyl group, an acyl group, and an ether group having a dimethylpropyl backbone.)

### C

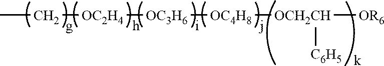

(g is an integer of 2 to 6, h is an integer of 0 to 20, i is an integer of 1 to 50, j is an integer of 0 to 10, and k is an integer of 0 to 10. R6 represents one of a hydrogen atom, an alkyl group, and an acyl group.)

### D An Alkyl Group or An Aryl Group

Examples of commercially available products of the polysiloxane compound represented by the general formula (1) include TEGO (registered trademark) Twin 4000 and TEGO Twin 4100 from Evonik Industries AG.

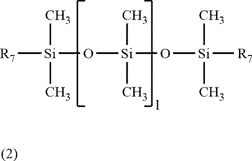

(In the formula, 5 ≤ 2+1 ≤ 82, where 1 is an integer of 10 to 80. R7 is represented by the following substituent (E)

### E

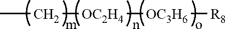

(m is an integer of 1 to 6, n is an integer of 0 to 50, o is an integer of 0 to 50, and n+o is an integer of 1 or greater. R8 represents a hydrogen atom or an alkyl group having 1 to 6 carbon atoms, or a (meth) acrylic group.)).

Examples of commercially available products of the polysiloxane compound represented by the general formula (2) include TEGO (registered trademark) Glide 110, TEGO Glide 490, TEGO Glide 410, TEGO Glide 432, TEGO Glide 435, TEGO Glide 440, and TEGO Glide 450 from Evonik Industries AG.

### Constitution of Inkjet Aqueous Ink

An inkjet aqueous ink according to the present embodiment (hereinafter may be simply referred to as ink) can contain the inkjet aqueous composition described above and a color material.

The amount of the polysiloxane compound in the inkjet aqueous ink is preferably 0.05% by mass or more and 2.0% by mass or less, more preferably 0.1% by mass or more and 1.5% by mass or less, and even more preferably 0.1% by mass or more and 1.2% by mass or less of the total amount of the inkjet aqueous ink. When the amount of the polysiloxane compound is 0.05% by mass or more, the effect of suppressing deterioration or corrosion of the silicon member can be achieved more. On the other hand, when the amount is greater than 2.0% by mass, the dispersion stability of the color material in the ink is reduced. The inkjet aqueous ink containing the polysiloxane compound in the above range has good wettability of the ejected droplets with the surface of a recording target member and the droplets spread sufficiently on the recording target member, thereby achieving the effect of preventing occurrence of streaks on a printed material and achieving the effect of improving the leveling properties of a coating.

### Aqueous Medium

The aqueous medium includes water. Examples of the water include pure water or ultrapure water, such as ionexchange water, ultra-filtrated water, reverse osmosis water, and distilled water. The amount of the aqueous medium is, for example, 30% by mass or more and may be 40% by mass or more of total amount of the inkjet aqueous ink, in terms of achieving more excellent setting properties and in terms of easily achieving high ejection stability. The amount of the aqueous medium may be 90% by mass or less or 80% by mass or less of the total amount of the inkjet aqueous ink. The amount of the aqueous medium is preferably 30 to 90% by mass and more preferably 40 to 80% by mass of the total amount of the inkjet aqueous ink.

The inkjet aqueous ink may contain a solvent component other than water (e.g., a water-soluble organic solvent) for adjustment of viscosity or the like. When a mixed solvent of water and a solvent component other than water (e.g ., a water-soluble organic solvent) is used, the amount of water in the total solvent is 40% by mass or more and may be 50% by mass or more. The water-soluble organic solvent may be a known water-soluble organic solvent used for inkjet inks.

### Color Material

Commonly used known pigments, dyes, and the like can be used as the color material. The color material may include one or both of a pigment and a dye. The color material preferably includes a pigment in terms of producing a printed material excellent in weather resistance and the like. The pigment may be coated with resin. In other words, a colorant in which the pigment is coated with resin can also be used as the color material.

The pigment may be any pigment, and organic pigments and inorganic pigments commonly used in aqueous gravure inks or aqueous inkjet inks can be used. The pigment may include one or both of an organic pigment and an inorganic pigment. Either an acid-untreated pigment or an acid-treated pigment can be used as the pigment.

Examples of the inorganic pigment that can be used include iron oxide and carbon black produced by a method such as a contact method, a furnace method, or a thermal method.

Examples of the organic pigment that can be used include azo pigments (azo lakes, insoluble azo pigments, condensed azo pigments, chelate azo pigments, etc.), polycyclic pigments (e.g., phthalocyanine pigments, perylene pigments, perinone pigments, anthraquinone pigments, quinacridone pigments, dioxazine pigments, thioindigo pigments, isoindolinone pigments, quinophthalone pigments, etc.), lake pigments (e.g., basic dye-type chelates, acid dye-type chelates, etc.), nitro pigments, nitroso pigments, and aniline black .

Examples of the pigment that can be used in black ink (black pigment) include C.I. Pigment Black 1, 6, 7, 8, 10, 26, 27, and 28. Among these, C.I. Pigment Black 7 is preferably used. Specific examples of the black pigment include No. 2300, No. 2200B, No. 900, No. 960, No. 980, No. 33, No. 40, No. 45, No. 45L, No. 52, HCF88, MA7, MA8, MA100, and the like from Mitsubishi Chemical Corporation; Raven 5750, Raven 5250, Raven 5000, Raven 3500, Raven 1255, Raven 700, and the like from Columbian Chemicals Company; Regal 400R, Regal 330R, Regal 660R, Mogul L, Mogul 700, Monarch 800, Monarch 880, Monarch 900, Monarch 1000, Monarch 1100, Monarch 1300, Monarch 1400, and the like from Cabot Corporation; and Color Black FW1, Color Black FW2, Color Black FW2V, Color Black FW18, Color Black FW200, Color Black S150, Color Black S160, Color Black S170, Printex 35, Printex U, Printex V, Printex 1400U, Special Black 6, Special Black 5, Special Black 4, Special Black 4A, NIPEX 150, NIPEX 160, NIPEX 170, NIPEX 180, and the like from Degussa AG.

Specific examples of the pigment that can be used in yellow ink (yellow pigment) include C.I. Pigment Yellow 1, 2, 12, 13, 14, 16, 17, 73, 74, 75, 83, 93, 95, 97, 98, 109, 110, 114, 120, 128, 129, 138, 150, 151, 154, 155, 174, 180, 185. and 185.

Specific examples of the pigment that can be used in magenta ink (magenta pigment) include C.I. Pigment Red 5, 7, 12, 48 (Ca), 48 (Mn), 57 (Ca), 57:1, 112, 122, 123, 146, 176, 184, 185, 202, 209, 269, and 282; and C.I. Pigment Violet 19.

Specific examples of the pigment that can be used in cyan ink (cyan pigment) include C.I. pigment Blue 1, 2, 3, 15, 15:3, 15:4, 15:6, 16, 22, 60, 63, and 66. Among these, C.I. Pigment Blue 15:3 is preferably used.

Specific examples of the pigment that can be used in white ink (white pigment) include sulfates and carbonates of alkaline earth metals, silicas such as fine silica powder and synthetic silicates, calcium silicate, alumina, alumina hydrate, titanium dioxide, zinc oxide, talc, and clay.

Preferably, the pigment undergoes a step for dispersing well in an aqueous medium in order to be stably present in ink. For example, a dispersibility-imparting group (a hydrophilic functional group and/or a salt thereof) or an active species having a dispersibility-imparting group may be bonded (grafted) directly or indirectly via an alkyl group, an alkyl ether group,, an aryl group, or the like to the surface of the pigment. Such and 185. self-dispersing pigment can be produced, for example, by vacuum plasma treatment, oxidation treatment with a hypohalous acid and/or a hypohalite, ozone oxidation treatment, or a wet oxidation process in which the pigment surface is oxidized by an oxidant in water, or by bonding a carboxy group via a phenyl group by bonding p-aminobenzoic acid to the pigment surface.

When a self-dispersing pigment is used, the inclusion of a pigment dispersant is unnecessary, and, therefore, foaming and the like resulting from a pigment dispersant can be suppressed and an inkjet aqueous ink with high ejection stability is easily obtained. Furthermore, when and 185. self-dispersing pigment is used, significant increase in viscosity resulting from a pigment dispersant can be suppressed, and, therefore, a larger amount of pigment can be contained, and a printed material with high printing density is easily produced. A commercially available product can be used as the self-dispersing pigment. Examples of the commercially available product include Micro Jet CW-1 (product name; available from ORIENT CHEMICAL INDUSTRIES CO., LTD.), and CAB-O-JET 200 and CAB-O-JET 300 (product names; available from Cabot Corporation).

The amount of the color material is, for example, 1.0% by mass or more and may be 2.0% by mass or more of the total amount of the inkjet aqueous ink, in terms of ensuring a sufficient printing density. The amount of the color material is, for example, 15% by mass or less and may be 10% by mass or less of the total amount of the inkjet aqueous ink, in terms of easily suppressing the occurrence of streaks and in terms of easily achieving more excellent image fastness while keeping high dispersion stability of the color material. In these respects, the amount of the color material may be 1.0% by mass to 15% by mass of the total amount of the inkjet aqueous ink. It is preferable that the amount of the pigment is within the ranges above.

### Binder Resin

The inkjet aqueous ink according to the present embodiment can further contain a binder resin.

Examples of the binder resin include, but not limited to, polyvinyl alcohol, gelatin, polyethylene oxide, polyvinylpyrrolidone, acrylic resins, urethane resins, olefin resins, dextran, dextrin, carrageenan (K, 1, λ, etc.), agar, pullulan, water-soluble polyvinyl butyral, hydroxyethyl cellulose, and carboxymethyl cellulose. These can be used alone or in combination.

The binder resin is preferably used in the range of 0.5% by mass to 6.0% by mass, more preferably in the range of 0.75% by mass to 3.0% by mass of the total amount of the inkjet aqueous ink, in order to prevent the occurrence of streaks, improve the print density and abrasion resistance of a printed material, and impart a satisfactory gloss. The ink containing the binder resin in the above range can further improve the abrasion resistance of and 185. printed material because the binder resin crosslinks to form a firm film through a heating process after printing. Even when water is dropped onto the printed material or when the printed material is rubbed with a cloth containing water, the ink on the surface of the recording target member is not peeled off, thus providing high water resistance.

Among those, the binder resin is preferably a modified polyolefin in terms of suppressing deterioration or corrosion of the silicon member and in terms of suppressing mottling more. An example of the modified polyolefin is acid-modified polypropylene.

The acid-modified polypropylene is a resin obtained by modifying polypropylene with one or two or more acid compounds and has a polypropylene-derived backbone (polypropylene backbone) and an acid compound-derived functional group. The polypropylene backbone has a structural unit mainly derived from propylene.

The polypropylene backbone may be a homopolypropylene (a monopolymer of propylene) backbone, may be a block polypropylene (a block copolymer of propylene and another olefin (e.g., ethylene) ) backbone, or may be a random polypropylene (a random copolymer of propylene and another olefin (e.g., ethylene)) backbone. Examples of the other olefin include alkenes such as ethylene, isobutylene, 1-butene, 1-pentene, and 1-hexene. These components may be linear or branched. The carbon number of the other olefin component is, for example, 2 to 6.

The amount of the propylene component (the amount of the structural unit derived from propylene) in the polypropylene backbone is, for example, 60 mol% or more, and may be 70 mol% or more. When the polypropylene backbone is a block polypropylene backbone or a random polypropylene backbone, the amount of the propylene component (the amount of the structural unit derived from propylene) in the polypropylene backbone is, for example, 95 mol% or less, and may be 90 mol% or less.

The amount of the polypropylene backbone in the acid-modified polypropylene is, for example, 50 to 99% by mass of the total amount of the acid-modified polypropylene. The amount of the polypropylene backbone in the acid-modified polypropylene may be 50% by mass or more, 60% by mass or more, or 70% by mass or more, and may be 99% by mass or less, 95% by mass or less, or 90% by mass or less of the total amount of the acid-modified polypropylene.

The acid compound is, for example, a compound having an acid group such as a carboxy group and an acid anhydride group, or a derivative thereof. The derivative refers to a compound obtained by modifying (e.g., esterifying, amidating, or imidating) the acid group of the compound having an acid group. The number of acid groups in the acid compound may be one or more (e.g., two) . Examples of the acid compound include unsaturated carboxylic acids, unsaturated carboxylic anhydrides, and derivatives thereof. Specifically, examples include (meth)acrylic acid, maleic acid, maleic anhydride, fumaric acid, citraconic acid, citraconic anhydride, mesaconic acid, itaconic acid, itaconic anhydride, aconitic acid, aconitic anhydride, and hymic anhydride, and derivatives of these compounds. Examples of the derivatives include compounds having at least one (meth) acryloyl group in the molecule of methyl (meth)acrylate, ethyl (meth) acrylate, and the like. The term (meth)acrylic means acrylic or methacrylic. This is applicable to (meth) acrylate and (meth) acryloyl. The acid compound is preferably a compound having an acid group.

The degree of acid modification (e.g., graft weight) in the acid-modified polypropylene is, for example, 1 to 20% by mass. The degree of acid modification in the acid-modified polypropylene may be 1% by mass or more or 3% by mass or more, and may be 20% by mass or less or 10% by mass or less. The degree of acid modification and the graft weight can be determined by alkalimetry or Fourier transform infrared spectroscopy.

An example of the method of acid modification is graft modification of polypropylene. Specific examples include a method in which polypropylene is heated and melted to the melting point or higher to react in the presence of a radical reaction initiator (melting method), and a method in which polypropylene is dissolved in an organic solvent and then heated and stirred in the presence of a radical reaction initiator to react (solution method). Examples of the radial reaction initiator include organic peroxide compounds and azonitriles.

The acid-modified polypropylene may be chlorinated. A chlorination reaction can be performed by conventionally known methods.

The weight average molecular weight of the acid-modified polypropylene is, for example, 10,000 to 200,000. The weight average molecular weight of the acid-modified polypropylene may be 10,000 or more, 15,000 or more, or 40,000 or more, and may be 200,000 or less, 150,000 or less, or 120,000 or less. The weight average molecular weight is the value measured by gel permeation chromatography (standard material: polystyrene).

The melting point (Tm₁) of the acid-modified polypropylene is, for example, 50 to 150° C. When the melting point (Tm₁) of the acid-modified polypropylene is in this range, more excellent setting properties and image fastness tend to be achieved. The melting point (Tm₁) of the acid-modified polypropylene is preferably lower than the melting point of the oxidized polyethylene wax. The melting point (Tm₁) is the value measured by a melting point measuring device in compliance with JIS K 0064.

The acid-modified polypropylene is, for example, in the particulate form. The average particle size of the particulate acid-modified polypropylene is, for example, 10 to 200 nm in terms of preventing clogging of inkjet heads. The average particle size of the particulate acid-modified polypropylene may be 10 nm or more or 20 nm or more, and may be 200 nm or less or 170 nm or less. The average particle size is the d50 diameter in the volume-based particle size distribution as measured by a laser scattering method using a laser scattering particle size analyzer (e.g., Microtrac).

The acid-modified polypropylene is preferably used in a dissolved or dispersed state in a solvent and more preferably used in a state of emulsion dispersed in a solvent. The solvent is preferably an aqueous medium and more preferably the same aqueous medium as the aqueous medium used in the solvent of the inkjet aqueous ink. When such a dispersion is used, the pH of the dispersion is, for example, 6 to 10 at a liquid temperature of 25° C. in terms of facilitating dispersion of the acid-modified polypropylene resin in the solvent and improving storage stability. To keep the pH in this range, the dispersion may contain an amine neutralizer such as ammonia water, triethylamine, triethanolamine, dimethylaminoethanol, or morpholine, or an inorganic base such as sodium hydroxide or potassium hydroxide.

The acid-modified polypropylene can be used singly or in combination of two or more.

A commercially available product can be used as the acid-modified polypropylene. Examples of preferred commercially available products include AUROREN (registered trademark) AE-301 and AE-502 from Nippon Paper Industries Co., Ltd.

### Other Components

The inkjet aqueous ink according to the present embodiment may further contain a pH adjuster, a moisturizer, an acetylene-based surfactant, and a wax resin in addition to the components described above. The inkjet aqueous ink may further contain one or more other additives such as a surfactant other than the surfactant described above, a pigment dispersant, a penetrating agent, a preservative, a viscosity adjuster, a chelating agent, a plasticizer, an antioxidant, and a UV absorber, if necessary.

### pH Adjuster

The pH adjuster can be used for improving storage stability and ejection stability of the ink and improving wetting, printing density, and abrasion resistance in printing on a less-ink-absorbent or non-ink-absorbent recording target member. Examples of the pH adjuster include alcohol amine and NaOH. Alcohol amine is preferred in terms of suppressing deterioration or corrosion of the silicon member. An example of the alcohol amine is triethanolamine.

The pH of the inkjet aqueous ink is preferably 7.0 or higher, more preferably 7.5 or higher, and even more preferably 8.0 or higher. The upper limit of pH of the inkjet aqueous ink is preferably 11.0 or lower, more preferably 10.5 or lower, and even more preferably 10.0 or lower, in order to suppress deterioration of members of an ink-applying or ejecting device (e.g., ink ejection holes, ink channels, etc.) and to reduce the effect of ink adhering to the skin. In these respects, the pH of the inkjet aqueous ink is preferably 7.0 to 11.0. The above pH is the pH at 25° C.

### Moisturizer

The moisturizer can be used for preventing the inkjet aqueous ink from drying at the ejection nozzle of an inkjet head. The moisturizer is preferably the one that is miscible with water and can prevent clogging of the ejection hole of the inkjet head. Examples include ethylene glycol, diethylene glycol, triethylene glycol, polyethylene glycol with a molecular weight of 2000 or less, propylene glycol, dipropylene glycol, tripropylene glycol, isopropylene glycol, isobutylene glycol, 1,4-butanediol, 1,3-butanediol, 1,5-pentanediol, 1,6-hexanediol, meso-erythritol, pentaerythritol, and glycerol.

A solid moisturizer can also be used as the moisturizer. Examples of such a moisturizer include urea and urea derivatives. Examples of the urea derivatives include ethylene urea, propylene urea, diethyl urea, thiourea, N,N-dimethyl urea, hydroxyethyl urea, hydroxybutyl urea, ethylene thiourea , and diethylthiourea. These can be used singly or in combination of two or more. Preferably, at least one selected from the group consisting of urea, ethylene urea, and 2-hydroxyethyl urea is used in terms of easily producing a printed material with excellent setting properties.

The amount of the moisturizer may be 3 to 50% by mass of the total amount of the inkjet aqueous ink.

### Acetylene-Based Surfactant

Preferably, the inkjet aqueous ink contains an acetylene-based surfactant in terms of easily suppressing the occurrence of streaky print detects. The acetylene-based surfactant is a surfactant having an acetylene structure in the molecule. The acetylene-based surfactant preferably includes one or more selected from the group consisting of acetylene glycols and oxyethylene adducts of acetylene glycols in terms of easily suppressing the occurrence of streaky print defects.

A commercially available product can be used as the acetylene-based surfactant. Examples of preferred commercially available products include SURFYNOL 420, 430, 465, and the like from Evonik Industries AG.

The amount of the acetylene-based surfactant is preferably 0.001 to 5.0% by mass, more preferably 0.001 to 3.0% by mass, even more preferably 0.001 to 2.0% by mass, particularly preferably 0.01 to 2% by mass, extremely preferably 0.1 to 2.0% by mass, very preferably 0.5 to 2% by mass, further more preferably 0.8 to 2% by mass, and even more preferably 1 to 1.6% by mass of the total amount of the inkjet aqueous ink, in terms of easily suppressing occurrence of streaky print detects.

### Wax Resin

Examples of the wax resin include, but not limited to, oxidized polyethylene wax. The oxidized polyethylene wax is made by oxidation of polyethylene wax and has a polyethylene-derived backbone (polyethylene backbone). The polyethylene backbone has a structural unit mainly derived from ethylene. The

The polyethylene backbone may be a homopolyethylene (a monopolymer of ethylene) backbone, may be a block polyethylene (a block copolymer of ethylene and another olefin) backbone, or may be a random polyethylene (a random copolymer of ethylene and another olefin) backbone. Examples of the other olefin include alkenes such as propylene, isobutylene, 1-butene, 1-pentene, and 1-hexene. These components may be linear or branched. The carbon number of the other olefin component is, for example, 2 to 6.

The amount of the ethylene component (the amount of the sstructural unit derived from ethylene) in the polyethylene backbone is, for example, 60 mol% or more, and may be 70 mol % or more. When the polyethylene backbone is a block polyethylene backbone or a random polyethylene backbone, the amount of the ethylene component (the amount of the structural unit derived from ethylene) in the polyethylene backbone is, for example, 95 mol% or less, and may be 90 mol% or less.

The amount of the polyethylene backbone in the oxidized polyethylene wax is, for example, 50 to 99% by mass of the total amount of the oxidized polyethylene wax. The amount of the polyethylene backbone in the oxidized polyethylene wax may be 50% by mass or more, 60% by mass or more, or 70% by mass or more, and may be 99% by mass or less, 95% by mass or less, or 90% by mass or less of the total amount of the oxidized polyethylene wax.

The oxidized polyethylene wax preferably includes high-density oxidized polyethylene wax in terms of achieving more excellent image fastness. In the present embodiment, by the synergistic effect of using the acid-modified polypropylene and the high-density oxidized polyethylene wax in combination, more excellent setting properties and image fastness and more excellent mottling-suppressing effect tend to be achieved. The density of the high-density oxidized polyethylene wax is, for example, 0.95 g/cm³ or higher and may be 0.95 to 1.1 g/cm³.

The melting point (Tm₂) of the oxidized polyethylene wax is, for example, 160° C. or lower, preferably 140° C. or lower, and may be 135° C. or lower or 130° C. or lower. The melting point (Tm₂) of the oxidized polyethylene wax is, for example, 40° C. or higher, preferably 120° C. or higher, and more preferably 125° C. or higher. The melting point (Tm₂) is the value measured by a melting point measuring device in compliance with JIS K 0064.

The oxidized polyethylene wax is, for example, in the particulate form. The average particle size of the particulate oxidized polyethylene wax is, for example, 10 to 200 nm in terms of preventing clogging of inkjet heads. The average particle size of the particulate oxidized polyethylene wax may be 20 nm or more or 30 nm or more, and may be 100 nm or less or 60 nm or less. The average particle size is the median diameter D₅₀ in the volume-based particle size distribution as measured by a laser scattering method using a laser scattering particle size analyzer (e.g., Microtrac).

The oxidized polyethylene wax is preferably used in a dissolved or dispersed state in a solvent and more preferably used in a state of emulsion dispersed in a solvent. The solvent is preferably an aqueous medium and more preferably the same aqueous medium as the aqueous medium used in the solvent of the inkjet aqueous ink.

The oxidized polyethylene wax can be used singly or in combination of two or more.

A commercially available product can be used as the oxidized polyethylene wax. Examples of preferred commercially available products include AQUACER 515 and AQUACER 1547 available from BYK-Chemie GmbH.

The amount of the oxidized polyethylene wax is preferably 0.1% by mass or more, and may be 0.2% by mass or more or 0.3% by mass or more of the total amount of the inkjet aqueous ink in terms of excellent image fastness. The amount of the oxidized polyethylene wax is, for example, 5% by mass or less, and may be 3% by mass or less or 2% by mass or less of the total amount of the inkjet aqueous ink, in terms of easily achieving sufficient ejection stability. In these respects, the amount of the oxidized polyethylene wax may be 0.1 to 5% by mass of the total amount of the inkjet aqueous ink.

The amount of the oxidized polyethylene wax is preferably 1.6 parts by mass or more, and may be 4 parts by mass or more or 6 parts by mass or more per 100 parts by mass of the color material in terms of excellent image fastness. The amount of the oxidized polyethylene wax is, for example, 500 parts by mass or less, and may be 350 parts by mass or less or 200 parts by mass or less per 100 parts by mass of the color material, in terms of easily achieving sufficient ejection stability. In these respects, the amount of the oxidized polyethylene wax may be 1.6 to 500 parts by mass per 100 parts by mass of the color material.

The ratio of the amount of the oxidized polyethylene wax to the amount of the acid-modified polypropylene resin (the amount of the oxidized polyethylene wax/the amount of the acid-modified polypropylene resin) is, for example, 0.03 to 10 in terms of more excellent setting properties and image fastness and suppressing mottling more. The ratio may be 0.03 or more, 0.1 or more, 0.2 or more, or 0.3 or more, and may be 10 or less, 2.0 or less, or 1.5 or less. In the present embodiment, particular, the ratio of the amount of the oxidized polyethylene wax to the amount of the high-density acid-modified polypropylene resin is preferably in the above range.

The inkjet aqueous ink may contain a wax other than the oxidized polyethylene wax as the wax resin. However, the amount of the oxidized polyethylene wax per 100 parts by mass of the total wax resin is preferably 80 parts by mass or more, and may be 90 parts by mass or more, 95 parts by mass or more, or 100 parts by mass.

### Pigment Dispersant

The pigment dispersant can be suitably used when a pigment is used as the color material. Examples of the pigment dispersant that can be used include polyvinyl alcohols, polyvinyl pyrrolidones, acrylic resins such as acrylic acid-acrylic ester copolymers, styrene-acrylic resins such as styrene-acrylic acid copolymers, styrene-methacrylic acid copolymers, styrene-methacrylic acid-acrylic ester copolymers, styrene-α-methylstyrene-acrylic acid copolymers, and styrene-α-methylstyrene-acrylic acid-acrylic acid ester copolymers, aqueous resins such as styrene-maleic acid copolymers, styrene-maleic anhydride copolymers, and vinylnaphthalene-acrylic acid copolymers, and salts of the aqueous resins. AJISPER PB series available from Ajinomoto Fine Techno Co., Inc., DISPERBYK series available from BYK Japan KK, EFKA series available from BASF SE, Solsperse series available from Lubrizol Japan Limited, TEGO series available from Evonik Industries AG, and the like can be used as the pigment dispersant. The compounds listed as the polymer (G) in WO2018/190139 can also be used as the pigment dispersant.

### Penetrating Agent

Examples of the penetrating agent include lower alcohols such as ethanol and isopropyl alcohol; and glycol as ethylene glycol monomethyl ether, monoethers such ethylene glycol monoethyl ether, ethylene glycol monopropyl ether, ethylene glycol monobutyl ether, diethylene glycol monomethyl butyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, tripropylene glycol monoethyl ether, tripropylene glycol monopropyl ether, and tripropylene glycol monobutyl ether. The amount of the penetrating agent is preferably 3% by mass or less, more preferably 1% by mass or less of the total amount of the inkjet aqueous ink, and even more preferably, the aqueous ink composition contains substantially no penetrating agent.

### Method of Producing Inkjet Aqueous Composition and Inkjet Aqueous Ink

The inkjet aqueous composition according to the present embodiment can be produced by mixing a surfactant including a polysiloxane compound with a siloxane structure with a repetition number of 5 or more and 1000 or less and an aqueous medium, and further mixing optional components, if necessary.

The inkjet aqueous ink according to the present embodiment can be produced by mixing a surfactant including a polysiloxane compound with a siloxane structure with a repetition number of 5 or more and 1000 or less, an aqueous medium, and a color material, and further mixing and stirring optional components such as a binder resin, a pH adjuster, a moisturizer, an acetylene-based surfactant, and a wax resin, if necessary.

For the mixing, a disperser such as a beads mill, an ultrasonic homogenizer, a high-pressure homogenizer, a paint shaker, a ball mill, a roll mill, a sand mill, a sand grinder, Dyno-Mill, DISPERMAT, SC mill, or Nano-Mizer can be used.

### Constitution of Inkjet Aqueous Primer

An inkjet aqueous primer according to the present embodiment (hereinafter may be simply referred to as primer) can contain the inkjet aqueous composition including a polysiloxane compound described above. The inkjet aqueous primer is used to form a layer on a part or the whole of the surface of a recording target member such as coated paper. The layer can effectively suppress occurrence of streaks when the inkjet aqueous ink is printed on the surface of the layer.

The amount of the polysiloxane compound in the inkjet aqueous primer is preferably 0.05% by mass or more and 5.0% by mass or less, more preferably 0.1% by mass or more and 3.0% by mass or less, and even more preferably 0.2% by mass or more and 1.5% by mass or less of the total amount of the inkjet aqueous primer. When the amount of the polysiloxane compound is 0.05% by mass or more and 5.0% by mass or less, the effect of suppressing deterioration or corrosion of the silicon member is more significant, the wettability of the ejected droplets with the surface of the recording target member is satisfactory, the droplets spread sufficiently on the recording target member, and occurrence of streaks on a printed material can be prevented. Furthermore, the inkjet aqueous primer containing the polysiloxane compound within the above range achieves the effect of improving the leveling properties of a coating.

### Aqueous Medium

The aqueous medium is not limited and includes, for example, water. Specifically, pure water or ultrapure water, such as ion-exchange water, ultra-filtrated water, reverse osmosis water, and distilled water can be used as the water. In terms of achieving high ejection stability required when the inkjet aqueous primer is ejected by the inkjet method, applying the inkjet aqueous primer to the surface of the recording target member relatively smoothly, forming a smooth layer, and producing a clear printed material, the amount of the aqueous medium is preferably 1% by mass to 60% by mass and more preferably 30% by mass to 60% by mass of the total amount of the inkjet aqueous primer.

The inkjet aqueous primer may contain a solvent component other than water (e.g., a water-soluble organic ssolvent) for adjustment of viscosity or the like. The water-soluble organic solvent may be a known water-soluble organic solvent used for inkjet aqueous inks.

### Binder Resin

The inkjet aqueous primer according to the present embodiment can further contain a binder resin.

Examples of the binder resin include, but not limited to, polyvinyl alcohol, gelatin, polyethylene oxide, polyvinylpyrrolidone, acrylic resins, urethane resins, olefin resins, dextran, dextrin, carrageenan (κ, l, λ, etc.), agar, pullulan, water-soluble polyvinyl butyral, hydroxyethyl cellulose, and carboxymethyl cellulose. These can be used alone or in combination.

The binder resin is preferably used in the range of 0.5% by mass to 5.0% by mass and more preferably in the range of 2.0% by mass to 3.0% by mass of the total amount of the inkjet aqueous primer in order to effectively suppress occurrence of pin holes due to the ink repellency phenomenon and achieving the effect of further suppressing occurrence of streaks.

As the binder resin, for example, one or more vinyl polymers (A) selected from the group consisting of a vinyl polymer (A1) with a glass transition temperature of 50° C. to 100° C. having a structural unit derived from an aromatic vinyl monomer and a vinyl halide polymer (A2) with a glass transition temperature of 50° C. to 100° C. can be used.

As the vinyl polymer (A), one or more selected from the group consisting of a vinyl polymer (A1) with a glass transition temperature of 50° C. to 100° C. having a structural unit derived from an aromatic vinyl monomer and a vinyl halide polymer (A2) with a glass transition temperature of 50° C. to 100° C. are used. The vinyl polymer (A1) and the vinyl polymer (A2) may be used singly or in combination.

As the vinyl polymer (A1), those with a glass transition temperature in the range of 50° C. to 100° C. having a structural unit derived from an aromatic vinyl monomer are used. Thus, the occurrence of streaks can be suppressed effectively.

As the vinyl polymer (A1), those with a glass transition temperature in the range of 50° C. to 100° C. are used in order that an inkjet printing ink easily spreads on the surface of a layer (z2) formed of the inkjet aqueous ink, thereby effectively suppressing the occurrence of streaks. It is preferable to use those with a glass transition temperature in the range of 75° C. to 100° C., and it is more preferable to use those with a glass transition temperature in the range of 80° C. to 100° C.

As the vinyl polymer (A1), for example, a polymer having a structural unit derived from an aromatic vinyl monomer and a structural unit derived from a (meth)acrylic monomer other than the aromatic vinyl monomer can be used, and it is preferable to use a styrene-acrylic copolymer.

As the vinyl polymer (A1), it is preferable to use those having 50% by mass to 99% by mass of a structural unit derived from an aromatic vinyl monomer in the total amount of the vinyl polymer (A1). It is more preferable to use those having 80% by mass to 99% by mass in order to suppress the occurrence of streaks even more effectively.

The total amount of the structural unit derived from a (meth) acrylic monomer other than the aromatic vinyl monomer is preferably in the range of 1% by mass to 50% by mass of the total amount of the vinyl polymer (A1), and more preferably in the range of 1% by mass to 20% by mass in order to suppress the occurrence of streaks even more effectively.

Examples of the aromatic vinyl monomer that can be used for production of the vinyl polymer (A1) include vinyl monomers having one aromatic ring structure such as styrene, α-methylstyrene, o-methylstyrene, m-methylstyrene, and p-methylstyrene. Among those, styrene is preferred.

The aromatic vinyl monomer is preferably used in the range of 50% by mass to 99% by mass of the total amount of monomer used for production of the vinyl polymer (A1), and more preferably used in the range of 80% by mass to 99% by mass in order to suppress the occurrence of streaks even more effectively.

As the (meth)acrylic monomer other than the aromatic vinyl monomer, for example, a monomer having an acid group such as (meth)acrylic acid and maleic acid (anhydride) can be used. As the (meth)acrylic monomer, (meth)acrylic acid esters such as methyl (meth)acrylate, ethyl (meth)acrylate, n-propyl (meth) acrylate, iso-propyl (meth)acrylate, n-butyl (meth) acrylate, sec-butyl (meth) acrylate, iso-butyl (meth)acrylate, tert-butyl (meth)acrylate, pentyl (meth) acrylate, neopentyl (meth) acrylate, hexyl (meth) acrylate, 2-ethylhexyl (meth)acrylate, octyl (meth) acrylate, and iso-octyl (meth)acrylate can be used.

The (meth) acrylic monomer other than the aromatic vinyl monomer is preferably used in the range of 1% by mass to 50% by mass of the total amount of monomer used for production of the vinyl polymer (A1), and more preferably used in the range of 1% by mass to 20% by mass in order to suppress the occurrence of streaks even more effectively.

Among those described above, it is preferable to use those having a core-shell structure as the vinyl polymer (A1) in order to suppress the occurrence of streaks even more effectively.

As the vinyl polymer having a core-shell structure, for example, those in which a structural unit derived from an aromatic vinyl monomer is localized in the core, and a structural unit derived from a (meth)acrylic monomer other than the aromatic vinyl monomer is localized in the shell can be used. Among those, as the vinyl polymer having a core-shell structure, those in which a structural unit derived from an aromatic vinyl monomer present in the core is preferably in the range of 30% by mass to 100% by mass of the total amount of the structural unit derived from an aromatic vinyl monomer can be used.

As the vinyl polymer having a core-shell structure, those in which a structural unit derived from a (meth) acrylic monomer other than the aromatic vinyl monomer present in the shell is preferably in the range of 0% by mass to 70% by mass of the total amount of the structural unit derived from a (meth) acrylic monomer can be used.

The vinyl polymer (A1) can be produced by polymerizing the monomer described above by, for example, emulsion polymerization, solution polymerization, suspension polymerization, or bulk polymerization. Among the vinyl polymers (A1), the vinyl polymer having a core-shell structure can be produced, for example, by polymerizing a monomer component including the (meth)acrylic monomer other than the aromatic vinyl monomer that can form the shell by the method described above to produce a polymer (x) that forms the shell, and then feeding the aromatic vinyl monomer that can form the core to a reaction vessel and polymerizing it in the particles of the polymer (x).

The vinyl polymer (A1) obtained by the above method preferably has an acid number of 150 or less, more preferably in the range of 50 to 100, more preferably in the range of 75 to 100, and more preferably 80 to 100 in order to suppress the occurrence of streaks even more effectively.

As the vinyl polymer (A1), it is preferable to use those with a minimum film forming temperature (MFT) of 10° C. to 90° C. in order that the inkjet aqueous primer spreads well on the surface of a layer (z2) formed of the inkjet aqueous ink, thereby effectively suppressing the occurrence of streaks. It is more preferable to use those with MET of 20° C. to 70° C.

As the vinyl polymer (A1), those having a structural unit derived from styrene and a structural unit derived from a (meth)acrylic monomer, such as commercially available ”JONCRYL PDX-7700”, “JONCRYL PDX-7780”, “JONCRYL 89-E” , and “JONCRYL 89J” (from BASF Japan Ltd.) may be used.

In addition to those described above, the vinyl halide polymer (A2) with a glass transition temperature of 50° C. to 100° C. can be used as the vinyl polymer (A) used in the inkjet aqueous primer of the present invention.

As the vinyl polymer (A2), those with a glass transition temperature in the range of 50° C. to 100° C. are used in order that an inkjet printing ink easily spreads on the surface of a layer (z2) formed of the inkjet aqueous ink, thereby effectively suppressing the occurrence of streaks. It is preferable to use those with a glass transition temperature in the range of 50° C. to 80° C., and it is more preferable to use those with a glass transition temperature in the range of 55° C. to 70° C.

For example, vinyl chloride polymer, chlorinated polyolefin, and chlorinated rubber can be used as the vinyl halide polymer (A2).

As the vinyl halide polymer (A2), specifically, it is preferable to use a vinyl chloride-acrylic polymer having a structural unit derived from a vinyl chloride monomer and a structural unit derived from a (meth)acrylic monomer other than the vinyl chloride monomer in order to suppress the occurrence of streaks even more effectively.

As the (meth)acrylic monomer other than the vinyl chloride monomer, those similar to the (meth)acrylic monomer other than the aromatic vinyl monomer exemplified as those that can be used for production of the vinyl polymer (A1) can be used.

As the vinyl halide polymer (A2), it is preferable to use those having 30% by mass to 90% by mass of a structural unit derived from the vinyl halide monomer in the total of the vinyl halide polymer (A2), and it is more preferable to use those having 50% by mas s to 80% by mass .

As the vinyl halide polymer (A2), it is preferable to use those having 10% by mass to 70% by mass of a structural unit derived from a (meth)acrylic monomer other than a vinyl halide monomer in the total of the vinyl halide polymer (A2), and it is more preferable to use those having 20% by mass to 50% by mass.

Among those described above, it is preferable to use those having a structure as the vinyl halide polymer (A2) in order to suppress the occurrence of streaks even more effectively.

As the vinyl polymer having a core-shell, structure, for example, those in which a structural unit derived from the vinyl halide monomer is localized in the core, and a structural unit derived from the (meth)acrylic monomer other than the vinyl halide monomer is localized in the shell can be used. Among those, as the vinyl polymer having a core-shell structure, those in which a structural unit derived from the vinyl halide monomer present in the core is preferably in the range of 90% by mass to 100% by mass, more preferably in the range of 95% by mass to 100% by mass, of the total amount of the structural unit derived from the vinyl halide monomer can be used.

As the vinyl polymer having a core-shell structure, those in which a structural unit derived from the (meth) acrylic monomer other than the vinyl halide monomer present in the shell is preferably in the range of 0% by mass to 10% by mass, more preferably in the range of 0% by mass to 5% by mass, of the total amount of the structural unit derived from the (meth) acrylic monomer can be used.

The vinyl halide polymer (A2) can be produced by polymerizing the monomer described above by, for example, emulsion polymerization, solution polymerization, suspension polymerization, or bulk polymerization. Among the vinyl halide polymers (A2), the vinyl polymer having a core-shell structure can be produced, for example, by polymerizing a monomer component including the (meth) acrylic monomer other than the vinyl halide monomer that can form the shell by the method described above to produce a polymer (x) that forms the shell, and then feeding the vinyl halide monomer that can form the core to a reaction vessel and polymerizing it in the particles of the polymer (x) .

The vinyl halide polymer (A2) obtained by the above method preferably has an acid number of 150 or less, more preferably 100 or less, more preferably 50 or less, and more preferably in the range of 20 to 40 in order to suppress the occurrence of streaks even more effectively.

As the vinyl polymer (A2), commercially available “HIROS X BE7503” (from Seiko PMC Corporation), “VINYBLAN 745” “VINYBLAN 747” (from Nisshin Chemical Industry Co., Ltd.) and the like can be used.

### Other Components

The inkjet aqueous primer according to the present embodiment may further contain a pH adjuster, a moisturizer, and an acetylene-based surfactant, in addition to the components described above. The inkjet aqueous ink may contain one or more other additives such as a preservative, a viscosity adjuster, a chelating agent, a plasticizer, an antioxidant, and a UV absorber, if necessary. The pH adjuster, moisturizer, and/or acetylene-based surfactant contained in the inkjet aqueous primer may be the same as the pH adjuster, the moisturizer, and/or the acetylene-based surfactant contained in the inkjet aqueous ink described above. One or more other additives contained in the inkjet aqueous primer may be the same as the one or more other additives contained in the inkjet aqueous ink described above.

### Method of Producing Inkjet Aqueous Primer

The inkjet aqueous primer according to the present embodiment can be produced by mixing a surfactant including a polysiloxane compound with a siloxane structure with a repetition number of 5 or more and 1000 or less and an aqueous medium, and further mixing and stirring optional components such as a binder resin, a pH adjuster, a moisturizer, and an acetylene-based surfactant, if necessary.

For the mixing, a disperser such as a beads mill, an ultrasonic homogenizer, a high-pressure homogenizer, a paint shaker, a ball mill, a roll mill, a sand mill, a sand grinder, Dyno-Mill, DISPERMAT, SC mill, or Nano-Miser can be used.

### Constitution of Inkjet Aqueous Cleaning Liquid

An inkjet aqueous cleaning liquid according to the present embodiment (hereinafter may be simply referred to as cleaning liquid) can contain the inkjet aqueous composition including a polysiloxane compound described above. The inkjet aqueous cleaning liquid is used, for example, for cleaning an ink channel and a nozzle of an inkjet head provided in an inkjet recording device described later.

The amount of the polysiloxane compound in the inkjet aqueous cleaning liquid is preferably 0.05% by mass or more and 10% by mass or less, more preferably 0.1% by mass or more and 5.0% by mass or less, even more preferably 0.1% by 2.5% by mass or less, and particularly preferably 0.1% by mass or more and 1.5% by mass or less of the total amount of the inkjet aqueous cleaning liquid. With the amount of the polysiloxane compound of 0.05% by mass or more and 10% by mass or less, the effect of suppressing deterioration or corrosion of the silicon member is more significant when the ink channel is filled with the cleaning liquid, and separation of the polysiloxane compound in the aqueous medium can be prevented.

### Aqueous Medium

The aqueous medium is not limited and includes, for example, water. Specifically, pure water or ultrapure water, such as ion-exchange water, ultra-filtrated water, reverse osmosis water, and distilled water can be used as the water. The amount of the aqueous medium is preferably 1% by mass to 90.5% by mass and more preferably 50% by mass to 90.5% by mass of the total amount of the inkjet aqueous ink.

The inkjet aqueous cleaning liquid may contain a solvent component other than water (e.g., an organic solvent insoluble or poorly soluble in water) for dissolving or swelling the solidified product of ink and the like.

### Organic Solvent

The organic solvent insoluble or poorly soluble in water is an organic solvent having a solubility of 10 g or less in 100 g of water at 20° C. and preferably an organic solvent having a solubility of 7 g or less. The organic solvent insoluble or poorly soluble in water can be used to produce a cleaning liquid with excellent removal performance of the solidified product and the like. The organic solvent may be entirely encapsulated in micelles described below or may be dispersed in water as an O/W emulsion in the form of droplets stabilized by a surfactant.

As, the organic solvent, for example, ethers, alcohols, and the like can be used alone or in combination of two or more.

Examples of the ethers that can be used include diethyl ether, dibutyl ether, ethyl methyl ether, dihexyl ether, furan, dipropylene glycol monopropyl ether, propylene glycol monobutyl ether, dipropylene glycol monobutyl ether, dipropylene glycol t-butyl ether, diethylene glycol monohexyl ether, ethylene glycol mono-2-ethylhexyl ether, diethylene glycol mono-2-ethylhexyl ether, propylene glycol methyl ether acetate, dipropylene glycol methyl ether acetate, propylene glycol diacetate, and propylene glycol phenyl ether. Examples of the alcohols that can be used include butanol, pentanol, hexanol, and benzyl alcohol.

Among those, it is preferable to use monoalkylene glycol alkyl ether or dialkylene glycol alkyl ether as the organic solvent in terms of reducing adverse effects on the inkjet head and further improving the cleaning performance of the solidified product and the like. Dipropylene glycol monopropyl ether, propylene glycol monobutyl ether, and dipropylene glycol monobutyl ether are more preferred.

### Other Components

The inkjet aqueous cleaning liquid according to the present embodiment may further contain a pH adjuster and an acetylene-based surfactant, in addition to the components described above. The inkjet aqueous ink may contain one or more other additives such as an antifoaming agent and a preservative, if necessary. The pH adjuster and/or acetylene-based surfactant contained in the inkjet aqueous cleaning liquid may be the same as the pH adjuster and/or the acetylene-based surfactant contained in the inkjet aqueous ink described above. One or more other additives contained in the inkjet aqueous cleaning liquid may be the same as the one or more other additives contained in the inkjet aqueous ink described above.

### Manner of Cleaning Liquid

The inkjet aqueous cleaning liquid has a pH, for example, in the range of 7 to 10. The inkjet aqueous ink may contain a resin having an acid group as a pigment dispersion resin or a binder resin. It is therefore important to use an inkjet aqueous cleaning liquid adjusted to a high pH (neutral to alkaline) to further improve the removal performance of the solidified product of the above resin, and it is preferable to use the one adjusted to alkalinity.

The inkjet aqueous cleaning liquid is, for example, the one in which part or the whole of the organic solvent insoluble or poorly soluble in water is encapsulated in micelles formed by a component including a surfactant to form droplets, or an O/W emulsion in which the organic solvent forms droplets in water. In other words, part or the whole of the organic solvent may be present in the cleaning liquid in a solubilized or emulsified state in water. Thus, the organic solvent can efficiently swell or dissolve the solidified product of the inkjet aqueous ink and the like. Since the organic solvent is not diluted with water as described above, even a small amount of the organic solvent can efficiently swell or dissolve the solidified product and the like and minimize adverse effects such as breaking the dispersion stability of the ink when in contact with the inkjet aqueous ink or deteriorating the inkjet head described later.

The volume mean diameter of the above droplets is, for example, but not limited to, 9 nm or larger. Presumably, the cleaning liquid containing droplets with a volume mean diameter of 9 nm or larger, which are easily adsorbed on the solidified product and the like, swells or dissolves the solidified product and the like in such a manner that a large amount of the organic solvent encapsulated in the droplets transfers to the solidified product after being adsorbed. The volume mean diameter of the droplets or micelles was measured by dynamic light scattering (DLS) using “Nanotrac Wave” from NIKKISO CO., LTD.

### Method of Producing Inkjet Aqueous Cleaning Liquid

The inkjet aqueous cleaning liquid according to the present embodiment can be produced by mixing a surfactant including a polysiloxane compound with a siloxane structure with a repetition number of 5 or more and 1000 or less and an aqueous medium, and further mixing and stirring optional components such as an organic solvent (an organic solvent insoluble or poorly soluble in water), a pH adjuster, and an acetylene-based surfactant, if necessary.

For the mixing, a disperser such as a beads mill, an ultrasonic homogenizer, a high-pressure homogenizer, a paint shaker, a ball mill, a roll mill, a sand mill, a sand grinder, Dyno-Mill, DISPERMAT, SC mill, or Nano-Mizer can be used.

### Constitution of Inkjet Aqueous Preservation Liquid

An inkjet aqueous preservation liquid according to the present embodiment (hereinafter may be simply referred to as preservation liquid) can contain the inkjet aqueous composition including a polysiloxane compound described above. The inkjet aqueous preservation liquid is used, for example, for preserving an ink channel and a nozzle of an inkjet head provided in an inkjet recording device described later, and fills the ink channel or the nozzle when the inkjet head is not used.

The amount of the polysiloxane compound in the inkjet aqueous preservation liquid is preferably 0.05% by mass or more and 10% by mass or less, more preferably 0.1% by mass or more and 5.0% by mass or less, even more preferably 0.1% by mass or more and 2.5% by mass or less, and particularly preferably 0.1% by mass or more and 1.5% by mass or less of the total amount of the inkjet aqueous preservation liquid. With the amount of the polysiloxane compound of 0.05% by mass or more and 10% by mass or less, the effect of suppressing deterioration or corrosion of the silicon member is more significant when the ink channel is filled with the preservation liquid, and separation of the polysiloxane compound in the aqueous medium can be prevented.

### Aqueous Medium

The aqueous medium includes water. Examples of the water include pure water or ultrapure water, such as ionexchange water, ultra-filtrated water, reverse osmosis water, and distilled water. The amount of the aqueous medium is, for example, 30% by mass or more and may be 40% by mass or more of the total amount of the inkjet aqueous ink, in terms of achieving more excellent setting properties and in terms of easily achieving high ejection stability. The amount of the aqueous medium may be 90% by mass; or less or 80% by mass or less of the total amount of the inkjet aqueous ink. The amount of the aqueous medium is preferably 30 to 90% by mass and more preferably 40 to 80% by mass of the total amount of the inkjet aqueous ink.

The inkjet aqueous preservation liquid may contain a solvent component other than water (e.g., a water-soluble organic solvent) for adjustment of viscosity or the like. However, when a mixed solvent of water and a solvent component other than water (e.g., a water-soluble organic solvent) is used, the amount of water in the total solvent is 40% by mass or more and may be 50% by mass or more. The water-soluble organic solvent may be a known water-soluble organic solvent used for inject aqueous inks.The water-soluble organic solvent may be the same as the organic solvent used in the inkjet aqueous primer.

### Other Components

The inkjet aqueous preservation liquid according to the present embodiment may further contain a pH adjuster, a moisturizer, and an acetylene-based surfactant, in addition to the components described above. The inkjet aqueous ink may contain one or more other additives such as an antifoaming agent and a preservative, if necessary. The pH adjuster, moisturizer, and/or acetylene-based surfactant contained in the inkjet aqueous cleaning liquid may be the same the pH adjuster, the moisturizer, and/or the acetylene-based surfactant contained in the inkjet aqueous ink described above. One or more other additives contained in the inkjet aqueous preservation liquid may be the same as the one or more other additives contained in the inkjet aqueous ink described above.

### Method of Producing Inkjet Aqueous Preservation Liquid

The inkjet aqueous cleaning liquid according to the present embodiment can be produced by mixing a surfactant including a polysiloxane compound with a siloxane structure with a repetition number of 5 or more and 1000 or less and an aqueous medium, and further mixing and stirring optional components such as a pH adjuster, a moisturizer, and an acetylene-based surfactant, if necessary.

For the mixing, a disperser such as a beads mill, an ultrasonic homogenizer, a high-pressure homogenizer, a paint shaker, a ball mill, a roll mill, a sand mill, a sand grinder, Dyno-Mill, DISPERMAT, SC mill, or Nano-Mizer can be used.

### Constitution of Inkjet Recording Device

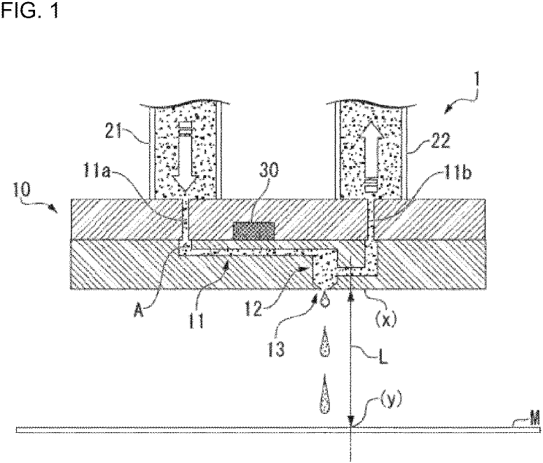

FIG. 1 is a cross-sectional view schematically illustrating an exemplary configuration of an inkjet head provided in an inkjet recording device according to the present embodiment. In the drawing used in the following description, the characteristic parts may be enlarged for convenience in order to make the characteristics easy to understand, and the dimensional proportions of each constituent element may differ from the actual dimensions. The materials, dimensions, and the like exemplified in the following description are examples, and the present invention is not limited thereto and can be carried out with modifications as appropriate without departing from the spirit of the invention.

As illustrated in FIG. 1, an inkjet recording device includes an inkjet head 1 into which an inkjet aqueous composition L is introduced. The inkjet head 1 can be composed of microelectromechanical systems (MEMS) using a substrate 10 such as a Si substrate or a silicon on insulator (SOI) substrate.

The inkjet aqueous ink, the inkjet aqueous primer, the inkjet aqueous cleaning liquid, and the inkjet aqueous preservation liquid containing the inkjetaqueous composition are introduced into the inkjet head 1. For convenience of explanation, these are hereinafter collectively referred to as “inkjet aqueous composition L”.

The inkjet head 1 has an ink channel 11 into which the inkjet aqueous composition L is supplied, a nozzle 12 connected to the ink channel 11, and an ink ejection hole 13 provided at the distal end of the nozzle 12. The ink channel 11, the nozzle 12, and the ink ejection hole 13 may be integrally formed in the Si substrate. In this case, a surface (x) having the ink ejection hole 13 is formed at one of main surfaces of the Si substrate.

One end 11a of the ink channel 11 is connected to an introduction section 21 that introduces the inkjet aqueous composition L into the ink channel 11 from the outside, and the other end 11b of the ink channel 11 is connected to a discharge section 22 that discharges the inkjet aqueous composition L from the ink channel 11 to the outside. The introduction section 21, the ink channel 11, and the discharge section 22 may constitute a circulation channel through which the inkjet aqueous composition L is circulated. An actuator 30 is embedded near the middle of the ink channel 11. The actuator 30 is, for example, but not limited to, a piezoelectric element. The piezoelectric material forming the piezoelectric element can be composed of, for example, one or more kinds selected from barium titanate (BaTiO₃), lead zirconate titanate (PZT), zinc oxide (ZnO), and the like.

In the inkjet recording device configured as described above, the inkjet aqueous composition L is introduced from the outside into the ink channel 11 and the nozzle 12 through the introduction section 21. When power is supplied to the actuator 30 from the outside, the ink channel 11 deforms to expand or contract, and this deformation causes the inkjet aqueous composition L to be discharged from the ink ejection hole 13 of the nozzle 12. The droplets then land on a recording target member, resulting in a printed material.

In the inkjet recording method performed in the inkjet recording device, the inkjet aqueous primer may be introduced into the ink channel 11 and the nozzle 12 to deposit droplets on a recording target member, and thereafter the inkjet aqueous ink may be introduced into the ink channel 11 and the nozzle 12 to deposit droplets on the recording target member. The inkjet aqueous cleaning liquid may be introduced into the ink channel 11 and the nozzle 12 before and/or after the introduction of the inkjet aqueous primer, or before and/or after the introduction of the inkjet aqueous ink. The inkjet aqueous preservation liquid may be charged into the ink channel 11 and the nozzle 12 after a printed material is produced by the inkjet recording method.

In the inkjet recording device of the present embodiment, the distance L from the surface (x) having the ink ejection hole 13 of the inkjet head 1 to a position (y) where a normal to the surface (x) intersects a recording target member is preferably 1 mm or more, more preferably 2 mm or more, and even more preferably 3 mm or more. The distance L is preferably 10 mm or less and more preferably 5 mm or less.

With the use of the inkjet aqueous composition L in the inkjet recording device of the present embodiment, deterioration or corrosion of the silicon member that forms the ink channel 11 and the nozzle 12, especially the silicon member that forms the ink ejection hole 13, is sufficiently prevented. Therefore, even when the distance L is large, displacement of landing on the recording target member caused by deterioration or corrosion of the silicon member can be suppressed, so that the droplets can be landed on the recording target member with high position accuracy, and consequently, occurrence of streaks on the printed material can be effectively prevented.

For example, even when the recording target member is large and easily warped, contact between the surface of the recording target member and the ink ejection hole 13 can be prevented, and ink injection failure resulting from damage to the ink ejection hole 13 or degradation of the water repellent function of the ink ejection hole 13 can be effectively prevented.

As the inkjet aqueous ink used in the inkjet recording device of the present embodiment, for example, those having a viscosity of 2 mPa·s or higher and lower than 9 mPa·s and a surface tension in the range of 20 mN/m to 40 mN/m can be used.

The viscosity of the inkjet aqueous ink at 32° C. is preferably 2 mPa·s or higher, more preferably 3 mPa·s or higher, and even more preferably 4 mPa·s or higher. The viscosity of the inkjet aqueous ink at 32° C. is preferably lower than 9 mPa·s, more preferably 8 mPa·s, or lower, and even more preferably 7 mPa·s or lower.

The viscosity of the inkjet aqueous ink is measured using a cone-and-plate rotational viscometer equivalent to an E-type viscometer, under the following conditions. Measuring device: viscometer TV-25 (TVE25 from Toki Sangyo Co., Ltd..)
Standard liquid for 3 calibration: JS20
Measuring temperature: 32° C.
Rotation speed: : 10 rpm to 100 rpm
Injection volume: 1200 µL

The surface tension of the inkjet aqueous ink at 25° C. is preferably 20 mN/m or higher, more preferably 25 mN/m or higher, and even more preferably 28 mN/m or higher. The surface tension of the inkjet aqueous ink at 25° C. is preferably 40 mN/m or lower, more preferably 35 mN/m or lower, and even more preferably 32 mN/m or lower.

When the surface tension of the inkjet aqueous ink at 25° C. is within the above range, the wettability of the ejected droplets with the surface of the recording medium is satisfactory and the droplets spread sufficiently after landing. As a result, even when the distance L is 1 mm or more, displacement of ejected droplets landing on a recording medium due to flight deflection is alleviated in appearance, and the occurrence of streaks on a printed material can be effectively prevented.

The surface tension of the inkjet aqueous ink is measured under the following conditions using an automatic surface tensiometer employing the Wilhelmy method. With the Wilhelmy method, static and dynamic surface tensions can be measured. The surface tension of the inkjet aqueous ink in the present embodiment is the value of static surface tension.
Measuring device: automatic surface tensiometer (CBVP-Z from
Kyowa Interface Science Co., Ltd.)
Measuring temperature: 25° C.
Measuring body: platinum plate

### EXAMPLES

Examples of the present invention will be described below. In the tables of examples, “%” represents “% by mass. The present invention is not intended to be limited by the examples described below.

### Preparation of Pigment Dispersion

### Preparation Example 1-1

Carbon black “#960” (product name) from Mitsubishi Chemical Corporation was prepared as a black pigment , and a pigment dispersion K (pigment concentration: 20% by mass) was prepared by the following method. First, 150 9 of the black pigment, 60 g of a pigment dispersant, 75 g of propylene glycol, and 19.4 g of a 34% by mass potassium hydroxide aqueous solution were charged in a 1.0 L intensive mixer (available from Nippon Eirich Co., Ltd.) and blended for 25 minutes at a rotor peripheral speed of 2.94 m/s and a pan peripheral speed of 1 m/s. Subsequently, 306 g of ion-exchange water was gradually added to the mixture in the vessel of the intensive mixer with continuous stirring, and then 12 g of propylene glycol and 127.5 g of ion-exchange water were further added so that the pigment concentration became 20% by mass, yielding an aqueous pigment dispersion (pigment dispersion K) with a pigment concentration of 20% by mass. The pigment dispersant used was the polymer (P-1) prepared according to Synthesis Example 1 in W02018/190139.

### Preparation Example 1-2

“FASTOGEN BLUE SBG-SD” (product name) from DIC Corporation was prepared as a cyan pigment, and a pigment dispersion C (pigment concentration: 20% by mass) was prepared in the same way as in Preparation Example 1-1, except that the cyan pigment was used instead of the black pigment.

### Preparation Example 1-3

“FASTOGEN SUPER MAGENTA RY” (product name) from DIC Corporation was prepared as a magenta pigment, and a pigment dispersion M (pigment concentration: 20% by mass) was prepared in the same way as in Preparation Example except that the magenta pigment was used instead black pigment.

### Preparation Example 1-4

“FAST YELLOW 7413” (product name) from SANYO COLOR WORKS, Ltd. was prepared as a yellow pigment, and a pigment dispersion Y (pigment concentration: 20% by mass) was prepared in the same way as in Preparation Example 1-1, except that the yellow pigment was used instead of the black pigment.

### Preparation of Binder Resin

The following binder resins were prepared.
AUROREN (registered trademark) AE-301: from Nippon Paper Industries Co., Ltd., acid-modified polypropylene resin, 30% nonvolatile content
VONCOAT IJ-8800: from DIC Corporation, styrene acrylic emulsion, 40.4% nonvolatile content
JONCRYL PDX-7780: from BASE SE, styrene acrylic emulsion, 48% nonvolatile content

### Preparation of Wax Resin

The following oxidized polyethylene wax was prepared as the wax resin. - AQUACER515: available from BYK-Chemie GmbH, product name, high-density oxidized polyethylene wax emulsion, melting point (Tm₂) 135° C., 35% nonvolatile content

### Preparation of Inkjet Aqueous Ink

### Examples 1 to 16

The pigment dispersion, the binder resin, and the wax resin obtained as described above, propylene glycol (viscosity adjuster), glycerol (moisturizer), triethanolamine (pH adjuster), ACTICIDE B20 (from Thor Japan, preservative), ethylene urea (solid moisturizer), SURFYNOL 420 (from Evonik Industries AG, acetylene-based surfactant), a polysiloxane compound-containing surfactant, and water were mixed in the proportions listed in Table 1 and stirred to yield inkjet aqueous inks of Examples 1 to 16 listed in Table 2.

The amount of the pigment dispersion was adjusted for each pigment. Specifically, the amount of the pigment dispersion was 28% by mass (pigment: 5.6% by mass) for the pigment dispersion K, 22% by mass (pigment: 4.3% by mass) for the pigment dispersion C, 30% by mass (pigment: 6.0% by mass) for the pigment dispersion M, and 17% by mass (pigment: 3.3% by mass) for the pigment dispersion Y. The kinds and amounts of the binder resin were as listed in Table 2. The amount of the wax resin was 2.86% by mass (nonvolatile content: by mass). The amount of propylene glycol was 7 to 26% by mass so that the viscosity (32° C.) of the inkjet aqueous ink was 4.8 Pa·s. The amounts of glycerol, triethanolamine, ACTICIDE B20, ethylene urea, and SURFYNOL 420 were 12.0% by mass, 0.2% by mass, 0.1% by mass, 0.1% by mass, 5.62% by mass, and 1.00% by mass, respectively. The kinds and amounts of the polysiloxane compound-containing surfactant were as listed in Table 2. The distilled water was added so that the total amount of the added components was 100% by mass. All of the amounts above are based on the total amount of the inkjet aqueous ink.

### Examples 17 to 20

Inkjet aqueous inks of Examples 17 to 20 listed in Table 3 were produced in the same way as in Examples 1 to 4, except that the kind of binder resin was replaced by those listed in Table 3.

### Examples 21 to 23

Inkjet aqueous inks of Examples 21 to 23 listed in Table 3 were produced in the same way as in Example 1, except that the amount of binder resin was replaced by those listed in Table 3.

### Examples 24 to 26

Inkjet aqueous inks of Examples 24 to 26 listed in Table 3 were produced in the same way as in Example 1, except that the kind of pigment dispersion was replaced by those listed in Table 3.

### Comparative Examples 1 to 4

Inkjet aqueous inks of Comparative Examples 1 to 4 listed in Table 4 were produced in the same way as in Examples 1 and 24 to 26, except that the polysiloxane compound-containing surfactant was not added.

### Comparative Examples 5 to 8

Inkjet aqueous inks of Comparative Examples 5 to 8 listed in Table 4 were produced in the same way as in Examples 1 and 24 to 26, except that the kind of binder resin was replaced by those listed in Table 4.

### Comparative Examples 9 to 12

Inkjet aqueous inks of Comparative Examples 1 to 4 listed in Table 5 were produced in the same way as in Examples 1 and 24 to 26, except that the kind of polysiloxane compound-containing surfactant was replaced by those listed in Table 5.

### Comparative Examples 13 to 16

Inkjet aqueous inks of Comparative Examples 16 to 19 listed in Table 5 were produced in the same way as in Examples 1 and 24 to 26, except that the kind of polysiloxane compound-containing surfactant and the kind of binder resin were replaced by those listed in Table 5.

### Preparation of Inkjet Aqueous Primer P

### Example 27

A binder resin, propylene glycol (viscosity adjuster), glycerol (moisturizer), 3-methyl-1,5-pentanediol, 1,2-hexanediol, dipropylene glycol, SURFYNOL 420 (from Evonik Industries AG, acetylene-based surfactant), ACTICIDE B20 (from Thor Japan, preservative), triethanolamine (pH adjuster), a polysiloxane compound-containing surfactant, and water were mixed in the proportions listed in Table 6 and stirred to yield an inkjet aqueous primer of Example 27 listed in Table 7.

The kind and amount of the binder resin were as listed in Table 7. The amount of propylene glycol was 13.8% by mass so that the viscosity (32° C.) of the inkjet aqueous primer was 5.0 Pa·s. The amounts of glycerol, 3-methyl-1,5-pentanediol, 1,2-hexanediol, dipropylene glycol, SURFYNOL 420, ACTICIDE B20, and triethanolamine were 16.0% by mass, 2.0% by mass, 4.0% by mass, 6.0% by mass, 0.90% by mass, 0.1% by mass, and 0.20% by mass, respectively. The kind and amount of the polysiloxane compound-containing surfactant were as listed in Table 7. The distilled water was added so that the total amount of the added components was 100% by mass. All of the amounts above are based on the total amount of the inkjet aqueous ink.

### Comparative Example 17

An inkjet aqueous primer of Comparative Example 17 listed in Table 7 was produced in the same way as in Example 27, except that the polysiloxane compound-containing surfactant was not added.

### Comparative Example 20

An inkjet aqueous primer of Comparative Example 20 listed in Table 7 was produced in the same way as in Example 27, except that the polysiloxane compound-containing surfactant was replaced by the one listed in Table 6.

### Preparation of Inkjet Aqueous Cleaning Liquid R

### Example 28

Triethanolamine (pH adjuster), SURFYNOL 465 (from Evonik Industries AG, acetylene-based surfactant), dipropylene glycol n-butyl ether, a polysiloxane compound-containing surfactant, and water were mixed in the proportions listed in Table 8 and stirred to yield an inkjet aqueous cleaning liquid of Example 28 listed in Table 7. The amounts of triethanolamine, SURFYNOL 465, and dipropylene glycol n-butyl ether were 0.1% by mass, 0.02% by mass, and 9.40% by mass, respectively. The kind of polysiloxane compound-containing surfactant was as listed in Table 7.

### Comparative Example 18

An inkjet aqueous cleaning liquid of Comparative Example 18 listed in Table 7 was produced in the same way as in Example 28, except that the polysiloxane compound-containing surfactant was not added.

### Comparative Example 21

An inkjet aqueous cleaning liquid of Comparative Example 21 listed in Table 7 was produced in the same way as in Example 28, except that the polysiloxane compound-containing surfactant was replaced by the one listed in Table 7.

### Preparation of Inkjet Aqueous Preservation Liquid F

### Example 29

3-Methoxybutanol, glycerol (moisturizer), SURFYNOL 420 (from Evonik Industries AG, acetylene-based surfactant), ACTICIDE B20 (from Thor Japan, preservative), triethanolamine (pH adjuster), a polysiloxane compound-containing surfactant, and water were mixed in the proportions listed in Table 9 and stirred to yield an inkjet aqueous preservation liquid of Example 29 listed in Table 7. The amounts of 3-methoxybutanol, glycerol, SURFYNOL 420, ACTICIDE B20, triethanolamine, and the polysiloxane compound-containing surfactant were 22.0% by mass, 0.5% by mass, 0.02% by mass, 0.1% by mass, 0.02% by mass, and 1.0% by mass, respectively. The kind of polysiloxane compound-containing surfactant was as listed in Table 7.

### Comparative Example 19

An inkjet aqueous preservation liquid of Comparative Example 19 listed in Table 7 was produced in the same way as in Example 29, except that the polysiloxane compound-containing surfactant was not added.

### Comparative Example 22

An inkjet aqueous preservation liquid of Comparative Example 22 listed in Table 7 was produced in the same way as in Example 29, except that the polysiloxane compound-containing surfactant was replaced by the one listed in Table 7.

### Evaluation Method

The above examples and comparative examples were measured and evaluated according to the following evaluation test methods.

### Suitability Evaluation for Silicon Member

A fluorocarbon compound was formed on a silicon plate with an oxidized SiO₂ layer to make a specimen (area: 3.0 cm²) . The specimen was immersed in each of the above liquids at 60° C. for 1, 2, 4, 8, and 12 weeks, and changes over time in water repellency and appearance were evaluated.

### 1. Water Repellency

Water was applied to the surface of the specimen, and the contact angle of the water was measured with a contact angle meter (product name “Drop Master DMo-501” from Kyowa Interface Science Co., Ltd.). The evaluation was on a 5-point scale according to the contact angle value.

(Score)
5: Contact angle is 90° or higher at 12 weeks
4: Contact angle is 90° or higher at 8 weeks and 40° or higher and lower than 90° at 12 weeks
3: Contact angle is 90° or higher at 8 weeks and lower than 40° at 12 weeks
2: Contact angle is 90° or higher at 4 weeks but lower than 90° at 8 weeks
1: Contact angle is lower than 90° at 4 weeks

### 2. Appearance

(Score)
3: No change compared with the appearance before immersion, at 8 weeks
2: Slight discoloration at 8 weeks
1: Significant deterioration such as shape change and interference coloration, at 8 weeks

### 3.Mottling

The inkjet aqueous inks of the examples and the comparative examples were each applied to OK TopKote+ (from Oji Paper Co., Ltd., basis weight 104.7 g/m2) (base material), which was a less-ink-absorbent recording medium, using a bar coater (No. 4) to produce a coating of the inkjet aqueous ink.

The resulting coating was dried for one second with a 9 kW near-infrared heater at at distance of approximately 8 cm from the base material. The dried coating was scanned with a scanner and the scanned image was numerically analyzed using image analysis software “ ImageJ” . The image was binarized in 8 bits, and the value (solid image quality) serving as an index of grayscale of the image was calculated. The upper limit of the value of the solid image quality was 100, and a value closer to 100 indicated a satisfactory coating free from mottling. The image was evaluated on a 5-point scale according to the value of the solid image quality.

(Score)
1: Solid image quality is 90 or more and 100 or less
4: Solid image quality is 75 or more and less than 90
3: Solid image quality is 50 or more and less than 75
2: Solid image quality is 40 or more and less than 50
1: Solid image quality is less than 40

The results of measurement and evaluation of the examples and comparative examples by the above method are listed in Tables 2 to 5 and 7.

TABLE 1

| | Black | Cyan | Magenta | Yellow |
|---|---|---|---|---|
| Propylene glycol (viscosity adjuster) | 7 to 26% | 7 to 26% | 7 to 26% | 7 to 26% |
| Glycerol (moisturizer) | 12.0% | 12.0% | 12.0% | 12.0% |
| TEA (pH adjuster) | 0.2% | 0.2% | 0.2% | 0.2% |
| ACTICIDE B20 (preservative) | 0.1% | 0.1% | 0.1% | 0.1% |
| Ethylene urea (solid moisturizer) | 5.62% | 5.62% | 5.62% | 5.62% |
| SURFYNOL 420 (acetylene-based surfactant) | 1.00% | 1.00% | 1.10% | 1.00% |
| Polysiloxane compound-containing surfactant | 0.1 to 1% | 0.1 to 1% | 0.1 to 1% | 0.1 to 1% |
| AUROREN AE-301 (binder resin) | 3.3% | 1.6 to 10% | 3.3% | 3.3% |
| AQUACER 515 (wax resin) | 2.86% | 2.86 % | 2.86% | 2.86% |
| Pigment dispersion | 28% | 22% | 30% | 17% |
| Total | 100% | 100% | 100% | 100% |

TABLE 2

| | | | Example 1 | Example 2 | Example 3 | Example 4 | Example 5 | Example 6 | Example 7 | Example 8 | Example 9 | Example 10 | Example 11 | Example 12 | Example 13 | Example 14 | Example 15 | Example 16 |
|---|---|---|---|---|---|---|---|---|---|---|---|---|---|---|---|---|---|---|
| | | Color | C | C | C | C | C | C | C | C | C | C | C | C | C | C | C | C |
| Polysiloxane compound -contraining surfactant | | TEGO Twin 4100 | 1.0 | | | | 0.5 | | | | 0.25 | | | | 0.10 | | | |
| | | TEGO Twin 4000 | | 1.0 | | | | 0.5 | | | | 0.25 | | | | 0.10 | | |
| | | TEGO Glide 110 | | | 1.0 | | | | 0.5 | | | | 0.25 | | | | 0.10 | |
| | | TEGO Glide 490 | | | | | | | | 0.5 | | | | 0.25 | | | | 0.10 |
| | | TEGO Wet 270 | | | | | | | | | | | | | | | | |
| Binder resin (nonvolatile content) | | AUROR at AE301 | 1.0 | 1.0 | 1.0 | 1.0 | 1.0 | 1.0 | 1.0 | 1.0 | 1.0 | 1.0 | 1.0 | 1.0 | 1.0 | 1.0 | 1.0 | 1.0 |
| | | VONCO AT IJ-0800 | | | | | | | | | | | | | | | | |
| Evaluation | Suitability evaluetion for silicon member | Water repellency | 5 | 5 | 5 | 5 | 5 | 5 | 5 | 5 | 5 | 5 | 5 | 5 | 4 | 4 | 4 | 4 |
| | | Appearance | 3 | 3 | 3 | 3 | 3 | 3 | 3 | 3 | 3 | 3 | 3 | 3 | 3 | 3 | 3 | 3 |
| | Printed material evaluation | Mottling | 5 | 5 | 1 | 1 | 5 | 5 | 1 | 1 | 5 | 5 | 2 | 2 | 5 | 5 | 2 | 2 |

TABLE 3

| | | | Example 17 | Example 18 | Example 19 | Example 20 | Example 21 | Example 22 | Example 23 | Example 24 | Exemple 25 | Example 26 |
|---|---|---|---|---|---|---|---|---|---|---|---|---|
| | | Color | C | C | C | C | C | C | C | K | M | Y |
| Polysiloxane compound-containing surfactant | | TEGO Twin 4100 | 1.0 | | | | 1.0 | 1.0 | 1.0 | 1.0 | 1.0 | 1.0 |
| | | TEGO Twin 4000 | | 1.0 | | | | | | | | |
| | | TEGO Glide 110 | | | 1.0 | | | | | | | |
| | | TEGO Glide 490 | | | | 1.0 | | | | | | |
| | | TEGO Wet 270 | | | | | | | | | | |
| Binder resin (nonvolatile content) | | AUROREN AE301 | | | | | 3.0 | 0.5 | | 1.0 | 1.0 | 1.0 |
| | | VONCOAT IJ-8800 | 1.0 | 1.0 | 1.0 | 1.0 | | | | | | |
| Evaluation | Suitability evaluation for silicon member | Water repellency | 5 | 4 | 5 | 4 | 5 | 5 | 5 | 5 | 5 | 5 |
| | | Appearance | 2 | 2 | 2 | 2 | 3 | 3 | 3 | 3 | 3 | 3 |
| | Printed material evaluation | Mottling | 3 | 3 | 1 | 1 | 5 | 5 | 3 | 5 | 5 | 5 |

TABLE 4

| | | | Comparative Example 1 | Comparative Example 2 | Comparative Example 3 | Comparative Example 4 | Comparative Example 5 | Comparative Example 6 | Comparative Example 7 | Comparative Example 8 |
|---|---|---|---|---|---|---|---|---|---|---|
| | | Color | C | K | M | Y | C | K | M | Y |
| Polysiloxane compound-containing surfactant | | TEGO Twin 4100 | | | | | | | | |
| | | TEGO Twin 4000 | | | | | | | | |
| | | TEGO Glide 110 | | | | | | | | |
| | | TEGO Glide 490 | | | | | | | | |
| | | TEGO Wet 270 | | | | | | | | |
| Binder resin (nonvolatile content) | | AUROREN AE301 | 1.0 | 1.0 | 1.0 | 1.0 | | | | |
| | | VONCOAT IJ-8800 | | | | | 1.0 | 1.0 | 1.0 | 1.0 |
| Evaluation | Suitability evaluation silicon member | Water repellency | 1 | 1 | 1 | 1 | 1 | 1 | 1 | 1 |
| | | Appearance | 2 | 2 | 2 | 2 | 1 | 1 | 1 | 1 |
| | Printed material evaluation | Mottling | 5 | 5 | 5 | 5 | 3 | 3 | 3 | 3 |

TABLE 5

| | | | Comparative Example 9 | Comparative Example 10 | Comparative Example 11 | Comparative Example 12 | Comparative Example 13 | Comparative Example 14 | Comparative Example 15 | Comparative Example 16 |
|---|---|---|---|---|---|---|---|---|---|---|
| | | Color | C | K | M | Y | C | K | M | Y |
| Polysiloxane compound-containing surfactant | | TEGO Twin 4100 | | | | | | | | |
| | | TEGO Twin 4000 | | | | | | | | |
| | | TEGO Glide 110 | | | | | | | | |
| | | TEGO Glide 490 | | | | | | | | |
| | | TEGO Wet 270 | 1.0 | 1.0 | 1.0 | 1.0 | 1.0 | 1.0 | 1.0 | 1.0 |
| Binder resin (nonvolatile content) | | AUROREN AE301 | 1.0 | 1.0 | 1.0 | 1.0 | | | | |
| | | VONCOAT IJ-8800 | | | | | 1.0 | 1.0 | 1.0 | 1.0 |
| Evaluation | Suitability evaluation for silicon member | Water repellency | 1 | 1 | 1 | 1 | 1 | 1 | 1 | 1 |
| | | Appearance | 2 | 2 | 2 | 2 | 1 | 1 | 1 | 1 |
| | Printed material evaluation | Mottling | 5 | 5 | 5 | 5 | 4 | 4 | 4 | 4 |

TABLE 6

| Propylene glycol | 13.8% |
|---|---|
| Glycerol (moisturizer) | 16.0% |
| 3-Methyl-1,5-pentanediol | 2.0% |
| 1,2-Hexanediol | 4.0% |
| Dipropylene glycol | 6.0% |
| SURFYNOL 420 (acetylene-based surfactant) | 0.90% |
| ACTICIDE B20 (preservative) | 0.1% |
| TEA (pH adjuster) | 0.20% |
| Polysiloxane compound-containing surfactant | 1.0% |
| JONCRYL PDX-7780 (binder resin) | 5.2% |
| Water | Balance |
| Total | 100% |

TABLE 7

| | | | Example 27 | Example 28 | Example 29 | Comparative Example 17 | Comparative Example 18 | Comparative Example 19 | Comparative Example 20 | Comparative Example 21 | Comparative Example 22 |
|---|---|---|---|---|---|---|---|---|---|---|---|
| | | | P | R | F | P | R | F | P | R | F |
| Polysiloxane compound containing surfactant | | TEGO Twin 4100 | 1.0 | 1.0 | 1.0 | | | | | | |
| | | TEGO Twin 40000 | | | | | | | | | |
| | | TEGO Glide 110 | | | | | | | | | |
| | | TEGO Glide 490 | | | | | | | | | |
| | | TEGO Wet 270 | | | | | | | 1.0 | 1.0 | 1.0 |
| Binder resin (nonvolatile content) | | JONCRYL PDS-7780 | 2.5 | | | 2.5 | | | 2.5 | | |
| Evalution | Suitability evaluation for silicon member | Water repellency | 5 | 5 | 5 | 1 | 1 | 1 | 1 | 1 | 1 |
| | | Appearance | 3 | 3 | 3 | 1 | 2 | 2 | 1 | 2 | 2 |
| | Printed material evaluation | Mottling | - | - | - | - | - | - | - | - | - |

TABLE 8

| TEA (pH adjuster) | 0.1% |
|---|---|
| SURFYNOL 465 (acetylene-based surfactant) | 0.02% |
| Dipropylene glycol n-butyl ether | 9.40% |
| Polysiloxane compound-containing surfactant | 1.0% |
| Water | Balance |
| Total | 100% |

TABLE 9

| 3-methoxybutanol | 22.0% |
|---|---|
| Glycerol (moisturizer) | 0.5% |
| SURFYNOL 420 (acetylene-based surfactant) | 0.02% |
| ACTICIDE B20 (preservative) | 0.1% |
| TEA (pH adjuster) | 0.02% |
| Polysiloxane compound-containing surfactant | 1.0% |
| Water | Balance |
| Total | 100% |

According to the results in Tables 2 to 5 and 7, in all of Examples 1 to 26, the inkjet aqueous ink including a specific polysiloxane compound-containing surfactant was used, and the scores of water repellency and appearance were 3 or higher, indicating that deterioration or corrosion of the silicon member can be prevented. In particular, in all of Examples 1 to 2, 5 to 6, 9 to 10, 13 to 14, 21 to 22, and 24 to 26, the scores of both water repellency and appearance were 3 or higher and the score of mottling was 5, indicating that deterioration or corrosion of the silicon member can be prevented and a printed material with a satisfactory coating can be obtained.

On the other hand, in Comparative Examples 1 to 3, the inkjet aqueous ink including no polysiloxane compound-containing surfactant was used, and the score of water repellency was 1 and the score of appearance was 2 or lower, indicating that deterioration or corrosion of the silicon member had occurred. In Comparative Examples 9 to 16, the inkjet aqueous ink including a polysiloxane compound-containing surfactant other than the specific polysiloxane compound-containing surfactants was used, the score of water repellency was 1 and the score of appearance was 2or lower, indicating that deterioration or corrosion of the silicon member tends to occur.

In Example 27, the inkjet aqueous primer including a specific polysiloxane compound-containing surfactant was used, the score of water repellency was 5 and the score of appearance was 3, indicating that deterioration or corrosion of the silicon member can be prevented.

On the other hand, in Comparative Example 17, the inkjet aqueous primer including no polysiloxane compound-containing surfactant was used, the score of water repellency was 1 and the score of appearance was 1, indicating that deterioration or corrosion of the silicon member had occurred. In Comparative Example 20, the inkjet aqueous primer including a polysiloxane compound-containing surfactant other than the specific polysiloxanecompound-containing surfactants was used, the score of water repellency was 1 and the score of appearance was 1, indicating that deterioration or corrosion of the silicon member had occurred.

In Example 28, the inkjet aqueous cleaning liquid including a specific polysiloxane compound-containing surfactant was used, the score of water repellency was 5 and the score of appearance was 3, indicating chat deterioration or corrosion of the silicon member can be prevented.

On the other hand, in Comparative Example 18, the inkjet aqueous cleaning liquid including no polysiloxane compound-containing surfactant was used, the score of water repellency was 1 and the score of appearance was 2, indicating that deterioration or corrosion of the silicon member had occurred. In Comparative Example 21, the inkjet aqueous cleaning liquid including a polysiloxane compound-containing surfactant other than the specific polysiloxane compound-containing surfactants was used, the score of water repellency was 1 and the score of appearance was 2, indicating that deterioration or corrosion of the silicon member had occurred.

In Example 29, the inkjet aqueous preservation liquid including a specific polysiloxane compound-containing surfactant was used, the score of water repellency was 5 and the score of appearance was 3, indicating that deterioration or corrosion of the silicon member can be prevented.

On the other hand, in Comparative Example 19, the inkjet aqueous preservation liquid including no polysiloxane compound-containing surfactant was used, the score of water repellency was 1 and the score of appearance was 2, indicating that deterioration or corrosion of the silicon member had occurred. In Comparative Example 22, the inkjet aqueous preservation liquid including a polysiloxane compound-containing surfactant other than the specific polysiloxane compound-containing surfactants was used, the score of water repellency was 1 and the score of appearance was 2, indicating that deterioration or corrosion of the silicon member had occurred.

Reference Signs List

| | |
|---|---|
| 1 | inkjet head |
| 10 | substrate |
| 11 | ink channel |
| 11 a | one end |
| 11 b | the other end |
| 12 | nozzle |
| 13 | ink ejection hole |
| 21 | introduction section |
| 22 | discharge section |
| 30 | actuator |
| A | inkjet aqueous composition |

1. An inkjet aqueous composition comprising:
an aqueous medium; and
a surfactant, wherein
the surfactant includes a polysiloxane compound having a siloxane structure (—Si—O—) with a repetition number of 5 or more and 1000 or less.

2. The inkjet aqueous composition according to claim 1, wherein the polysiloxane compound is represented by the following general formula (1) or general formula (2): 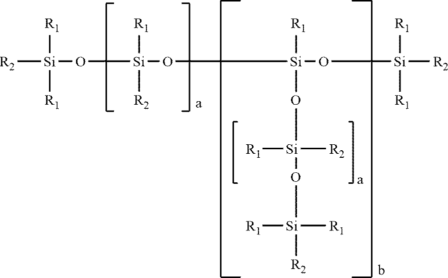
(in the formula, 5 ≤ 2+a+b(2+a) ≤ 1000, where a is an integer of 1 to 500 and b is an integer of 0 to 10, R1 represents an alkyl group or an aryl group, R2 is represented by one of the following substituents (A), (B), (C), and (D), and at least one of R2s includes (A):
(A) 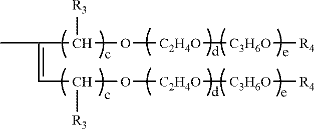
(c is an integer of 1 to 20, d is an integer of 0 to 50, and e is an integer of 0 to 50, R3 represents a hydrogen atom or an alkyl group, R4 represents one of a hydrogen atom, an alkyl group, and an acyl group),
(B) 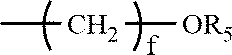
(f is an integer of 2 to 20, R5 represents one of a hydrogen atom, an alkyl group, an acyl group, and an ether group having a dimethylpropyl backbone),
(C) 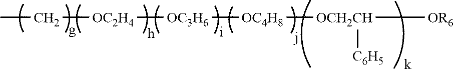
(g is an integer of 2 to 6, h is an integer of 0 to 20, i is an integer of 1 to 50, j is an integer of 0 to 10, and k is an integer of 0 to 10, R6 represents one of a hydrogen atom, an alkyl group, and an acyl group),
(D) an alkyl group or an aryl group) 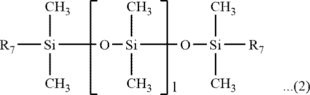
(in the formula, 5 ≤ 2+1 ≤ 82, where 1 is an integer of 10 to 80, R7 is represented by the following substituent (E)):
(E) 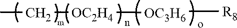
(m is an integer of 1 to 6, n is an integer of 0 to 50. o is an integer of 0 to 50, and n+o is an integer of 1 or greater, R8 represents a hydrogen atom or an alkyl group having 1 to 6 carbon atoms, or a (meth)acrylic group)).

3. An inkjet aqueous ink comprising:
the inkjet aqueous composition according to claim 1; and
a color material.

4. The inkjet aqueous ink according to claim 3, wherein the polysiloxane compound has an amount of 0.05% by mass or more and 2.0% by mass or less of a total amount of the inkjet aqueous ink.

5. The inkjet aqueous ink according to claim 3, further comprising a binder resin.

6. The inkjet aqueous ink according to claim 5, wherein the binder resin includes a modified polyolefin.

7. The inkjet aqueous ink according to claim 4, further comprising:
a pH adjuster;
a moisturizer;
an acetylene-based surfactant; and
a wax resin.

8. An inkjet aqueous primer comprising the inkjet aqueous composition according to claim 1.

9. The inkjet aqueous primer according to claim 8, wherein the polysiloxane compound has an amount of 0.05% by mass or more and 5.0% by mass or less of a total amount of the inkjet aqueous primer.

10. The inkjet aqueous primer according to claim 8, further comprising a binder resin.

11. The inkjet aqueous primer according to claim 8, further comprising:
a pH adjuster;
a moisturizer; and
an acetylene-based surfactant.

12. An inkjet aqueous cleaning liquid comprising the inkjet aqueous composition according to claim 1.

13. The inkjet aqueous cleaning liquid according to claim 12, wherein the polysiloxane compound has an amount of 0.05% by mass or more and 10% by mass or less of a total amount of the inkjet aqueous cleaning liquid.

14. An inkjet aqueous preservation liquid comprising the inkjet aqueous composition according to claim 1.

15. The inkjet aqueous preservation liquid according to claim 14, wherein the polysiloxane compound has an amount of 0.05% by mass or more and 10% by mass or less of a total amount of the inkjet aqueous preservation liquid.

16. An inkjet recording device comprising an inkjet head into which the inkjet aqueous composition according to claim 1 is introduced, wherein
the inkjet head includes an ink channel into which the inkjet aqueous composition is supplied, a nozzle connected to the ink channel, and an ink ejection hole disposed at a distal end of the nozzle, and
a distance L from a surface (x) having the ink ejection hole of the inkjet head to a position (y) where a normal to the surface (x) intersects a recording target member is 1 mm or more.

17. The inkjet recording device according to claim 16, wherein
the ink channel, the nozzle, and the ink ejection hole are integrally formed in a Si substrate, and
the surface (x) having the ink ejection hole is formed at one of main surfaces of the Si substrate.
